(19) United States
(12) Patent Application Publication
(10) Pub. No.: US 2018/0012298 A1
(43) Pub. Date: Jan. 11, 2018

(54) SYSTEMIC RISK MANAGEMENT SYSTEM, SYSTEMIC RISK MANAGEMENT METHOD, AND STORAGE MEDIUM STORING SYSTEMIC RISK MANAGEMENT PROGRAM

(71) Applicant: NEC Corporation, Minato-ku, Tokyo (JP)

(72) Inventor: Yoshiharu MAENO, Tokyo (JP)

(73) Assignee: NEC Corporation, Minato-ku, Tokyo (JP)

(21) Appl. No.: 15/550,087

(22) PCT Filed: Feb. 17, 2016
(86) PCT No.: PCT/JP2016/000829

§ 371 Date: Aug. 10, 2017

(30) Foreign Application Priority Data
Feb. 24, 2015 (JP) 2015-033996

(51) Int. Cl. G06Q 40/02; G06Q 40/06

(52) U.S. Cl. CPC G06Q 40/025; G06Q 40/06

(57) ABSTRACT

This systemic risk management system 100A comprises: an important bank designation unit 12 which, from multiple banks involved in interbank loans, designates an important bank on the basis of the smallness of a first bankruptcy scale, which is the scale of bankruptcy of the multiple banks that would be brought about due to the effects of a collapse of prescribed investments, funded by at least one of the multiple banks, in the case of preventing the bank included in the multiple banks from bankrupting due to the effects of the collapse of the aforementioned prescribed investments; and an important loan designation unit 13 which, from one or more interbank loans made by the important bank, designates an important interbank loan on the basis of the smallness of a second bankruptcy scale, which is the scale of bankruptcy of the multiple banks due to the effects of a collapse of the aforementioned investments in the case of preventing bankruptcy of the bank that is the borrower of the interbank loan included in the aforementioned one or more interbank loans and bankruptcy of the important bank caused by said collapse.

### TECHNICAL FIELD

The present invention relates to a technology that manages a systemic risk.

### BACKGROUND ART

A risk that the dysfunction of an individual financial institution or the like spreads to another financial institution or the entire financial system is commonly called a systemic risk.

In the following description including example embodiments, the systemic risk refers to a risk of collapse of the entire financial network, i.e., a risk of occurrence of very serious chain-reaction bankruptcies, rather than a risk of the bankruptcy of an individual bank. The financial network refers to, for example, a graph-like structure representing an interbank transaction relationship including an interbank loan of funds, as described later.

Examples of technologies relating to systemic risk management are described in NPL 1 to NPL 3.

In the technologies, the financial network is described using a mathematical model representing the bankruptcy of a bank caused by the propagation of losses across banks and the accumulation of the losses. Examples of input information input into the financial network include the financial affairs, investment and financing, and interbank loans of banks included in the financial network. The fundamental function of the systemic risk management is to estimate the scale of the number of chain-reaction bankruptcies from the financial network, thereby setting the estimated scale of the number of the chain-reaction bankruptcies as output information. The systemic risk is determined based on the scale of the number of the chain-reaction bankruptcies. The more the scale of the number of the chain-reaction bankruptcies is, the higher the systemic risk is. In particular, when the scale of the number of the chain-reaction bankruptcies is close to the number of the banks included in the financial network, the systemic risk can be considered to be so high that the entire financial network can collapse.

NPL 1 discloses the most fundamental mathematical model for estimating the scale of the number of chain-reaction bankruptcies.

NPL 2 discloses an advanced mathematical model taking, into consideration, the problems of the investment, financing, and asset liquidity of banks.

NPL 3 discloses a further advanced mathematical model taking, into consideration, the problem of a collective behavior seen in the investment and financing of banks.

An example of the models that are based on the technologies of NPL 1 to NPL 3 and estimate the scale of the number of chain-reaction bankruptcies is described below.

The investment and financing amount, interbank loan amount, and capital buffer amount of each bank are described in a financial management table. The investment and financing amount of each investment and financing destination of each bank is recorded in an investment and financing management table. The sum of the investment and financing amounts of all investment and financing destinations is equal to the investment and financing amount of the financial management table. In an interbank loan management table, the interbank loan amount of each bank that is a borrower is recorded for each bank that is a lender. The sum of the interbank loan amounts of all banks that are borrowers is equal to the interbank loan amount of the financial management table. A structure including banks connected to each other by such interbank loans is referred to as a financial network.

First, an assumption is that one of investment and financing destinations fails. A bank suffers a loss of which the amount is equal to an investment and financing amount for this investment and financing destination. If a capital buffer amount is more than the amount of the loss, the bank does not go bankrupt. If all banks do not go bankrupt, the loss of the failure of the investment and financing destination is absorbed. In addition, the function of a financial network is maintained without change. If the capital buffer amount is less than the amount of the loss, the bank goes bankrupt.

An interbank loan made to a borrower bank that becomes a bankrupt bank becomes irrecoverable. A bank that is a lender suffers the loss of the amount of the interbank loan. If the capital buffer amount is more than an amount of a loss caused by a failure of an investment and financing destination and a bankruptcy of a borrower bank, the bank does not go bankrupt. If the capital buffer amount is smaller, the bank results in chain-reaction bankruptcies. A bank that is a lender making a loan to the bank that goes into the chain-reaction bankruptcies suffers the loss of the amount of the interbank loan. Such a repetition causes the loss to propagate and the chain-reaction bankruptcies to spread out. When the chain no longer spreads out, the chain-reaction bankruptcies end. If the chain-reaction bankruptcies end, the number of banks that go bankrupt is totalized.

The scale of the number of chain-reaction bankruptcies in a case in which one of investment and financing destinations fail can be estimated by the models based on the technologies of NPL 1 to NPL 3. In other words, the magnitude of a systemic risk can be calculated.

### CITATION LIST

### Non Patent Literature

[NPL 1] E. Nier, J. Yang, T. Yorulmazer, A. Alentorn, Network models and financial stability, Journal of Economic Dynamics and Control vol. 31, pp. 2033-2060 (2007).
[NPL 2] A. G. Haldane, R. M. May, Systemic risk in banking ecosystems, Nature vol. 469, pp. 351-355 (2011). [NPL 3] N. Beale, D. G. Rand, H. Battey, K. Croxson, R. M. May, M. A. Nowak, Individual versus systemic risk and the Regulator's Dilemma, Proceedings of the National Academy of Sciences USA vol. 108, pp. 12647-12652 (2011).

### SUMMARY OF INVENTION

### Technical Problem

The technologies of NPL 1 to NPL 3 enable a calculation of the magnitude of a systemic risk by estimation of the number of chain-reaction bankruptcies. However, the technologies of NPL 1 to NPL 3 are incapable of determining which bank has finance that should be improved in order to reduce a systemic risk. In other words, the technologies of NPL 1 to NPL 3 are incapable of designating an important part in relation to a systemic risk in a financial network.

An object of the present invention is to provide a systemic risk management system capable of designating an important part in relation to a systemic risk in a financial network.

### Solution to Problem

A systemic risk management system according to an aspect of the present invention includes: important bank designation means for designating an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and important loan designation means for designating an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

A systemic risk management method according to an aspect of the present invention includes: designating an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and designating an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

A storage medium according to an aspect of the present invention stores a systemic risk management program that causes a computer to execute: important bank designation processing that designates an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and important loan designation processing that designates an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination. The present invention can also be achieved by the systemic risk management program stored in the storage medium described above.

### Advantageous Effects of Invention

The present invention has the effect of being capable of designating an important part in relation to a systemic risk in a financial network.

### BRIEF DESCRIPTION OF DRAWINGS

FIG. 1 is a block diagram illustrating an example of a configuration of systemic risk management systems of first, second, and third example embodiments of the present invention.

FIG. 2 is a view schematically illustrating an example of a bank financial management table of the first, the second, and the third example embodiments of the present invention.

FIG. 3 is a view schematically illustrating an example of an investment and financing management table of the first, the second, and the third example embodiments of the present invention.

FIG. 4 is a view schematically illustrating an example of an interbank loan management table of the first, the second, and the third example embodiments of the present invention.

FIG. 5 is a view schematically illustrating an example of a first additional capital buffer management table of the first example embodiment of the present invention.

FIG. 6 is a view schematically illustrating an example of a first chain-reaction bankruptcy number management table of the first example embodiment of the present invention.

FIG. 7 is a view schematically illustrating an example of a second additional capital buffer management table of the first example embodiment of the present invention.

FIG. 8 is a view schematically illustrating an example of a second chain-reaction bankruptcy number management table of the first example embodiment of the present invention.

FIG. 9 is a flowchart illustrating an example of an operation of a systemic risk management device of the first example embodiment of the present invention.

FIG. 10 is a flowchart illustrating an example of an operation of the systemic risk management device of the first example embodiment of the present invention.

FIG. 11 is a view schematically illustrating an example of a first chain-reaction bankruptcy number management table in the second example embodiment of the present invention.

FIG. 12 is a view schematically illustrating an example of a second chain-reaction bankruptcy number management table in the second example embodiment of the present invention.

FIG. 13 is a block diagram illustrating an example of a configuration of a systemic risk management system of a fourth example embodiment of the present invention.

FIG. 14 is a view illustrating an example of a hardware configuration of a computer with which each systemic risk management device according to the example embodiments of the present invention can be achieved.

FIG. 15 is a block diagram illustrating another example of the configuration of the systemic risk management system of the fourth example embodiment of the present invention.

FIG. 16 is a flowchart illustrating an example of an operation of the systemic risk management system according to the fourth example embodiment of the present invention.

FIG. 17 is a block diagram illustrating an example of configurations, implemented using a circuit, of the systemic risk management systems of the first, the second, and the third example embodiments of the present invention.

FIG. 18 is a block diagram illustrating an example of a configuration, implemented using a circuit, of the systemic risk management system of the fourth example embodiment of the present invention.

### DESCRIPTION OF EMBODIMENTS

A bank commonly makes investment and financing for supplying funds in the forms of financing and investment to a company and the like. Such a bank further makes an interbank loan for loaning funds to another bank. A financial network refers to, for example, a graph-like structure representing an interbank transaction relationship including an interbank loan of funds, as described above. When the data of the financial network is represented by a graph including nodes and an edge, a bank is represented by a node, and an interbank transaction is represented by an edge. In the following description, a company or the like in which investment and financing are made by a bank is referred to as “investment and financing destination.” An invested fund and a financed fund may be referred to as “investment and financing.” An interbank loan of funds is also referred to as “interbank loan.” A fund loaned through an interbank loan may also be referred to as “interbank loan.” A bank that is a lender which loans funds in an interbank loan is also referred to as “lender.” A bank that is a borrower to which funds are loaned in an interbank loan is also referred to as “borrower.”

In the description of each example embodiment of the present invention, when an investment and financing destination fails, investment and financing in the investment and financing destination are irrecoverable. In other words, the loss of the investment and financing in the investment and financing destination is caused. Hereinafter, the loss of investment and financing in an investment and financing destination that fails is referred to as a direct loss due to the failure of the investment and financing destination. The bankruptcy of a bank making investment and financing due to the loss of the investment and financing caused by the failure of an investment and financing destination is referred to as “bankruptcy due to failure of investment and financing destination” or the like.

When a bank that is a borrower of an interbank loan goes bankrupt, the interbank loan to the bank is irrecoverable. In other words, the loss of the interbank loan to the borrower is caused. The bankruptcy of a bank making an interbank loan due to the loss of the interbank loan caused by the bankruptcy of a borrower is referred to as “bankruptcy due to bankruptcy of bank that is borrower” or the like.

A loss referred to as “indirect loss due to failure of investment and financing destination” in the following description includes a loss of an interbank loan to a borrower due to a bankruptcy of a bank that is the borrower due to a direct loss caused by the failure of an investment and financing destination. The indirect loss due to the failure of the investment and financing destination further includes the loss of the interbank loan to a borrower caused by the bankruptcy of the bank that is the borrower due to the indirect loss due to the failure of the investment and financing destination or due to the combination of the direct loss and the indirect loss. “Bankruptcy of bank due to influence of failure of investment and financing destination” represents a bankruptcy of a bank due to at least either a direct loss or an indirect loss due to the failure of an investment and financing destination. “Chain-reaction bankruptcy” represents the bankruptcy of a bank due to the influence of the failure of the investment and financing destination described above. “Chain-reaction bankruptcy number” represents the number of the bankruptcies of banks due to the influence of the failure of an investment and financing destination, i.e., the number of banks going bankrupt due to chain-reaction bankruptcies.

Example embodiments of the present invention will now be described in detail with reference to drawings.

### First Example Embodiment

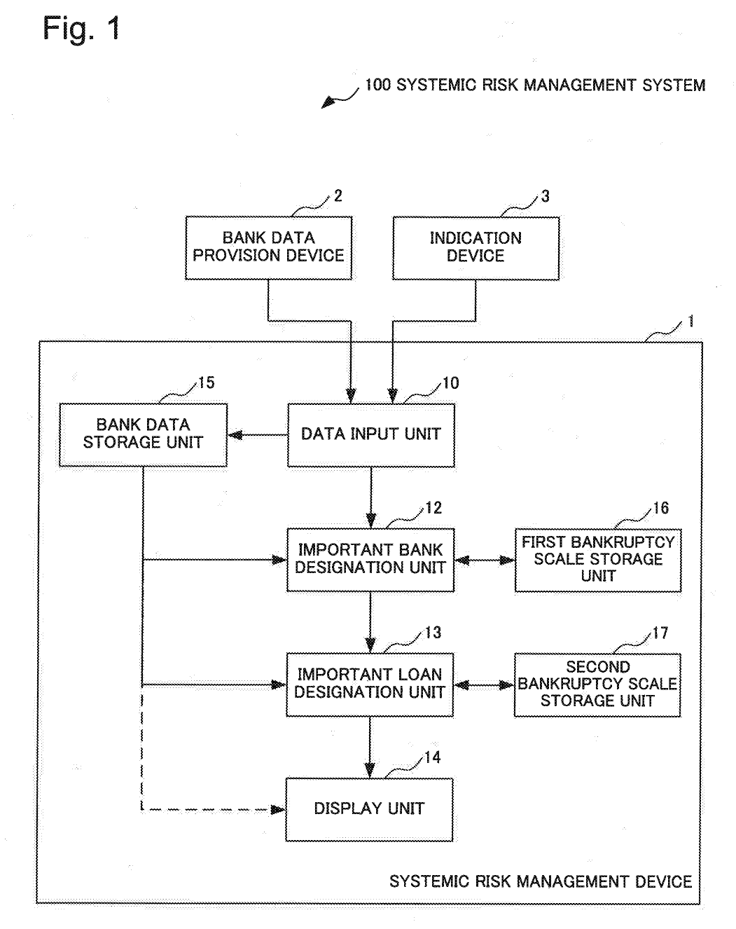

FIG. 1 is a block diagram illustrating an example of a configuration of a systemic risk management system 100 of a first example embodiment of the present invention. In FIG. 1 and other block diagrams described later, the directions of sending data are not limited to the directions of the drawn arrows. In the example illustrated in FIG. 1, the systemic risk management system 100 of the present example embodiment includes a systemic risk management device 1. The systemic risk management device 1 may be implemented as a single device as illustrated in the example in FIG. 1. The systemic risk management device 1 may be implemented as a plurality of devices which cooperatively operate, thereby performing the same operation as the operation of the systemic risk management device 1 implemented as the single device. When the systemic risk management device 1 is implemented as the plurality of devices, the plurality of devices may be connected communicably to each other through a communication network and the like. The communication network is implemented by at least either wired communication or wireless communication.

The systemic risk management system 100 further includes a bank data provision device 2 and an indication device 3. The systemic risk management device 1 is connected communicably to the bank data provision device 2 and the indication device 3 via a communication network and the like. The bank data provision device 2 and the indication device 3 may be implemented as the same device.

The systemic risk management device 1 includes a data input unit 10, an important bank designation unit 12, an important loan designation unit 13, a display unit 14, a bank data storage unit 15, a first bankruptcy scale storage unit 16, and a second bankruptcy scale storage unit 17.

The bank data provision device 2 provides bank financial information, investment and financing information, and interbank loan information to the systemic risk management device 1. The bank financial information is information about the financial affairs of a plurality of banks. The bank financial information includes the amount of the capital buffer, which is a capital that can be used for absorbing a loss, of each of the plurality of banks. The investment and financing information is information about the investment and financing of a bank. The investment and financing information includes the amount of the investment and financing made by each bank in each investment and financing destination of a bank. The interbank loan information is information of an interbank loan which is a loan from a bank that is a lender to a bank that is a borrower. The interbank loan information includes, for each interbank loan, the information of a bank (i.e., lender) that loans funds, the information of a bank (i.e., borrower) that borrows the funds from the bank, and the amount of the interbank loan. As described above, a financial network refers to a graph-like structure representing a relationship of an interbank transaction including an interbank loan. The financial network is represented by the interbank loan information. The bank financial information, the investment and financing information, and the interbank loan information are described in detail later.

Information provided to the systemic risk management device 1 by the bank data provision device 2 may be prepared by, for example, an administrator of the systemic risk management system 100 and stored in the bank data provision device 2 in advance. The information provided to the systemic risk management device 1 by the bank data provision device 2 may be information input into the bank data provision device 2 using, for example, an input device (not illustrated) such as a keyboard by, for example, the administrator of the systemic risk management system 100.

The indication device 3 sends information indicating an investment and financing destination that fails first (i.e., investment and financing destination ID (identification) of investment and financing destination that fails first) to the systemic risk management device 1. The investment and financing destination designated by the investment and financing destination ID sent to the systemic risk management device 1 is selected by, for example, the administrator of the systemic risk management system 100. The systemic risk management device 1 performs an operation described below on the assumption that the investment and financing destination of which the investment and financing destination ID is sent by the indication device 3 fails. In the following description, the investment and financing destination designated by the investment and financing destination ID sent to the systemic risk management device 1 is also referred to as “failed investment and financing destination.” The administrator of the systemic risk management system 100 or the like may select the failed investment and financing destination from investment and financing destinations in which investment and financing are made by at least any one of the banks included in the financial network described above. The indication device 3 may select the failed investment and financing destination, by a predetermined method, from investment and financing destinations in which investment and financing are made by at least any one of the banks included in the financial network described above.

The data input unit 10 acquires the bank financial information, the investment and financing information, and the interbank loan information from the bank data provision device 2. The data input unit 10 stores the bank financial information, the investment and financing information, and the interbank loan information, which are received, in the bank data storage unit 15. The data input unit 10 further receives the investment and financing destination ID from the indication device 3. The data input unit 10 sends the received investment and financing destination ID to the important bank designation unit 12. The bank financial information, the investment and financing information, and the interbank loan information are also referred to as “bank information.”

The bank data storage unit 15 stores the bank financial information, the investment and financing information, and the interbank loan information.

The important bank designation unit 12 receives the investment and financing destination ID of the failed investment and financing destination from the data input unit 10.

The important bank designation unit 12 specifies (i.e., selects), in turn, a bank included in the plurality of banks of the financial network. The important bank designation unit 12 derives a scale of bankruptcies of the plurality of banks included in the financial network (also referred to as “first scale of bankruptcies”) due to the influence of the failure of the failed investment and financing destination on condition that the bankruptcy of the specified bank due to the influence of the failure of the failed investment and financing destination is prevented. The important bank designation unit 12 repeats specification of a bank and derivation of the first scale of bankruptcies until any unspecified bank becomes absent in the plurality of banks included in the financial network.

As described above, the important bank designation unit 12 calculates the first scale of bankruptcies in a case of specifying each bank included in the plurality of banks included in the financial network. The important bank designation unit 12 may calculate the first scale of the bankruptcies on the basis of the bank financial information, the investment and financing information, and the interbank loan information stored in the bank data storage unit 15.

The important bank designation unit 12 designates an important bank on the basis of smallness of the first scale of bankruptcies with regard to each bank included in the plurality of banks included in the financial network. The important bank designation unit 12 may designate, for example, a bank with the smallest first scale of bankruptcies as the important bank. The important bank designation unit 12 sends the identifier (i.e., bank ID) of the designated important bank to the important loan designation unit 13.

When deriving the scale of the bankruptcies of the plurality of banks included in the financial network, the important bank designation unit 12 uses, for example, such a model for estimating the scale of the chain-reaction bankruptcy number, as described in Background Art. In other words, the important bank designation unit 12 uses the model to determine whether or not each of the plurality of banks included in the financial network goes into chain-reaction bankruptcies due to the influence of the failure of the failed investment and financing destination. In such a case, the important bank designation unit 12 may derive the chain-reaction bankruptcy number of banks due to the influence of the failure of the failed investment and financing destination, and may further derive an index value representing the scale of the bankruptcies of the plurality of banks as, for example, the scale of the bankruptcies of the plurality of banks on the basis of the derived chain-reaction bankruptcy number, for example, in a manner described below.

The important bank designation unit 12 derives the chain-reaction bankruptcy number due to the influence of the failure of the failed investment and financing destination for each sample. The important bank designation unit 12 may derive the chain-reaction bankruptcy number of the chain-reaction bankruptcies for each sample on the basis of the bank financial information, the bank investment and financing information, the interbank loan information, and the investment and financing destination ID of the failed investment and financing destination. The important bank designation unit 12 may use, for example, such a model as described in Background Art to derive the chain-reaction bankruptcy number. The important bank designation unit 12 determines the bankruptcy of a bank by comparing the amount of a loss with the amount of the capital buffer of the bank, for example, in a manner described below. The important bank designation unit 12 sets, as the amount of the loss, the sum of the amount of investment and financing made in a failed investment and financing destination by the bank of which the bankruptcy is determined and the amount of the interbank loan made by the bank to a bank that is a borrower determined to have already gone bankrupt.

For example, the important bank designation unit 12 first designates banks making investment and financing in a failed investment and financing destination. The important bank designation unit 12 determines whether or not each of the designated banks goes bankrupt due to the loss, caused by the failure of the failed investment and financing destination, of investment and financing in the failed investment and financing destination.

The important bank designation unit 12 further designates a bank making an interbank loan to a bank determined to go bankrupt (i.e., a bank that is the lender of an interbank loan to a bank that is a borrower determined to go bankrupt). The important bank designation unit 12 determines whether or not the designated bank goes bankrupt on the basis of the losses of the investment and financing in the failed investment and financing destination and the interbank loan of the borrower that goes bankrupt. The important bank designation unit 12 repeats the operation of designating a bank making an interbank loan to a bank newly determined to go bankrupt and determining whether or not the designated bank goes bankrupt until any bank newly determined to go bankrupt becomes absent.

When any bank newly determined to go bankrupt becomes absent, the important bank designation unit 12 totalizes, as the chain-reaction bankruptcy number, the number of the banks determined to go bankrupt.

The bankruptcy of a bank due to at least either the failure of a failed investment and financing destination or the bankruptcy of a bank that is a borrower of an interbank loan is a chain-reaction bankruptcy. The end of the chain of losses (and chain-reaction bankruptcies) represents that any bank newly determined to go bankrupt becomes absent. The number of banks determined to go bankrupt when any bank newly determined to go bankrupt becomes absent (i.e., when the chain of losses ends) is the chain-reaction bankruptcy number.

For example, a sufficient capital buffer may be further added to the capital buffer of a bank in order to prevent the bankruptcy of the bank due to the influence of the failure of a failed investment and financing destination. The amount of a loss estimated to be suffered by the bank due to the influence of the failed investment and financing destination can be considered as at most the sum of the amount of investment and financing in the failed investment and financing destination and the total amount of interbank loans made to other banks. Accordingly, the bankruptcy of the bank due to the influence of the failure of the failed investment and financing destination can be prevented by adding, to the capital buffer of the bank, a capital buffer of an amount that is the sum of the amount of the investment and financing in the failed investment and financing destination and the total amount of the interbank loans made to the other banks. In other words, the amount of the sufficient capital buffer described above is the sum of the amount of the investment and financing in the failed investment and financing destination and the total amount of the interbank loans made to the other banks.

In order to derive the scale of bankruptcies on condition of preventing the bankruptcy of a specified bank due to the influence of the failure of a failed investment and financing destination, the important bank designation unit 12 may temporarily make, for example, to data used for the derivation, a modification in which the specified bank is not determined to go into chain-reaction bankruptcies. Examples of such modifications include addition of the sufficient capital buffer described above to the capital buffer of the specified bank. The important bank designation unit 12 may use the data to which the above-described modification is made (for example, data to which a modification in which the sufficient capital buffer described above is added to the capital buffer of the specified bank is made) to derive the scale of the above-described bankruptcies. The important bank designation unit 12 may cancel the above-described modification after the derivation of the scale of the above-described bankruptcies with regard to the specified bank. For example, the important bank designation unit 12 may subtract the added capital buffer from the capital buffer of the specified bank. In the description of the example embodiments of the present invention, a capital buffer temporarily added to the capital buffer of a bank when the scale of the bankruptcies of plurality of banks included in a financial network is derived is referred to as an additional capital buffer. The amount of the sufficient capital buffer described above (i.e., the sum of the amount of investment and financing in a failed investment and financing destination and the total amount of interbank loans made to other banks) is referred to as “first additional capital buffer amount” or “amount of first additional capital buffer.”

When the scale of bankruptcies is derived on condition of preventing the bankruptcy of a specified bank due to the influence of the failure of a failed investment and financing destination, the important bank designation unit 12 may determine that the selected bank does not go bankrupt, for example, regardless of the amount of the loss of the specified bank. For example, even if it is determined that the specified bank goes bankrupt, the important bank designation unit 12 may continue the determination of chain-reaction bankruptcies without dealing with the interbank loan made to the specified bank as a loss. However, in the example embodiments of the present invention, a case in which the important bank designation unit 12 performs the derivation of the scale of bankruptcies, including the determination of chain-reaction bankruptcies, after the temporal addition of the amount of the first additional capital buffer to the amount of the capital buffer of the specified bank, is described.

For example, upon selecting a bank, the important bank designation unit 12 extracts the failed investment and financing destination, the amount of investment and financing made in the failed investment and financing destination, the borrower of the interbank loan, and the amount of the interbank loan, of the selected bank. The important bank designation unit 12 may store the extracted amount of the investment and financing and the extracted amount of the interbank loan as an additional capital buffer amount in the first bankruptcy scale storage unit 16. The information of the additional capital buffer amount of the bank stored in the first bankruptcy scale storage unit 16 is also referred to as “first additional capital buffer information.”

The important bank designation unit 12 may derive, as the first scale of the bankruptcies, an index value representing the first scale of bankruptcies (also referred to as “first index value”). The first index value is, for example, the number of banks, among plurality of banks included in a financial network, that go bankrupt due to the influence of the failure of a failed investment and financing destination under the condition that the bankruptcy of a specified bank due to the influence of the failure of the failed investment and financing destination is prevented. In the following description, the condition that the bankruptcy of the specified bank due to the influence of the failure of the failed investment and financing destination is prevented is referred to as “first condition.” In the example embodiments of the present invention, the derivation of the first index value performed under the first condition by the important bank designation unit 12 is the derivation of the first index value in the state of adding the first additional capital buffer amount to the amount of the capital buffer of the specified bank. In other words, the first index value is, for example, the chain-reaction bankruptcy number due to the influence of the failure of the failed investment and financing destination under the first condition in the plurality of banks included in the financial network. The first index value may be an index value that is not the above-described chain-reaction bankruptcy number, as described below. The important bank designation unit 12 stores information representing the derived first scale of bankruptcies (for example, first index value) in the first bankruptcy scale storage unit 16. In the following description, the information representing the first scale of bankruptcies is also referred to as “first bankruptcy scale information.” In particular, when the first scale of bankruptcies is represented by the chain-reaction bankruptcy number, the information representing the first scale of bankruptcies is also referred to as “first chain-reaction bankruptcy information.”

The first bankruptcy scale storage unit 16 stores the first additional capital buffer information and the first bankruptcy scale information (for example, first chain-reaction bankruptcy information).

The important loan designation unit 13 receives the bank ID of the designated important bank. The important loan designation unit 13 specifies (i.e., selects) one interbank loan from the interbank loans of the important bank, designated based on the interbank loan information. The important loan designation unit 13 derives the scale of the bankruptcies of a plurality of banks included in the financial network (referred to as “second scale of bankruptcies”) due to the influence of the failure of a failed investment and financing destination on condition of preventing the bankruptcy of the important bank due to the bankruptcy of the borrower of the specified interbank loan and the failure of a failed financing destination. The important loan designation unit 13 may repeat specification of an interbank loan and derivation of the second scale of bankruptcies until any interbank loan that is not specified becomes absent in the interbank loans of the important bank. As described above, the important loan designation unit 13 derives the second scale of bankruptcies in the case of specifying each of the interbank loans of the important bank. The important loan designation unit 13 may derive the second scale of bankruptcies on the basis of the bank financial information, the investment and financing information, and the interbank loan information which are stored in the bank data storage unit 15.

The important loan designation unit 13 designates an important interbank loan on the basis of the smallness of the second scale of bankruptcies with regard to each of the interbank loans of the important bank. The important loan designation unit 13 may designate, as the important interbank loan, for example, the interbank loan with the smallest second scale of bankruptcies. The important loan designation unit 13 sends the bank ID of the important bank and the identifier of the designated important interbank loan (i.e., loan ID) to the display unit 14. The loan ID may be the combination of the bank ID of a bank that is a lender and the bank ID of a bank that is a borrower. The loan ID may be an identifier which is assigned to each of the interbank loans, and may not be the combination of the bank ID of a bank that is a lender and the bank ID of a bank that is a borrower.

Similarly to the important bank designation unit 12, the important loan designation unit 13 uses, for example, such a model for estimating the scale of the chain-reaction bankruptcy number, as described in Background Art, when deriving the scale of the bankruptcies of the plurality of banks included in the financial network. In other words, the important loan designation unit 13 determines, by using the model, whether or not each of the plurality of banks included in the financial network goes into chain-reaction bankruptcies due to the influence of the failure of the failed investment and financing destination. A method of deriving the chain-reaction bankruptcies of banks and the chain-reaction bankruptcy number of the banks by the important loan designation unit 13 may be the same as the above-described method of deriving the chain-reaction bankruptcies of banks and the chain-reaction bankruptcy number of the banks by the important bank designation unit 12.

For example, a sufficient capital buffer may be added to the capital buffer of a bank in order to prevent the bankruptcy of the bank due to the failure of the failed investment and financing destination and the bankruptcy of the client of the specified interbank transaction. The amount of a loss estimated to be suffered by the bank due to the failed investment and financing destination is the amount of the investment and financing made in the failed investment and financing destination. The amount of a loss estimated to be suffered by the bank due to the bankruptcy of a borrower of an interbank loan, to which the fund is loaned by the bank, is the amount of the interbank loan. Accordingly, the bankruptcy of the bank due to the failure of the failed investment and financing destination and the bankruptcy of the bank that is the borrower of the specified interbank loan can be prevented by adding, to the capital buffer of the bank, a capital buffer that is the sum of the amount of the investment and financing in the failed investment and financing destination and the amount of the specified interbank loan. In other words, the sufficient capital buffer described above is the sum of the amount of the investment and financing in the failed investment and financing destination and the amount of the specified interbank loan.

The important loan designation unit 13 may perform such an operation as described below in order to derive the scale of bankruptcies in on condition of preventing the bankruptcy of the important bank due to the failure of the failed investment and financing destination and the bankruptcy of the bank that is the borrower of the specified interbank loan. The important loan designation unit 13 may temporarily make, for example, to data used for the derivation, a modification in which the important bank is not determined to go into chain-reaction bankruptcies. Examples of such modifications include the addition of the sufficient capital buffer described above to the capital buffer of the important bank. The important loan designation unit 13 calculates the sufficient capital buffer described above with regard to the specified interbank loan. The important loan designation unit 13 makes the above-described modification to the data used for the derivation. The important loan designation unit 13 may use the data to which the above-described modification is made (for example, data to which a modification in which the sufficient capital buffer described above is added to the capital buffer of the important bank is made) to derive the scale of the above-described bankruptcies. The important loan designation unit 13 may cancel the above-described modification after the derivation of the scale of the above-described bankruptcies with regard to the specified interbank loan. For example, the important loan designation unit 13 may subtract the added capital buffer from the capital buffer of the important bank. In the description of the example embodiments of the present invention, a capital buffer temporarily added to the capital buffer of a bank when the scale of the bankruptcies of plurality of banks included in a financial network is derived is referred to as an additional capital buffer. The amount of the sufficient capital buffer described above (i.e., the sum of the amount of investment and financing in a failed investment and financing destination and the amount of the specified interbank loan) is referred to as “second additional capital buffer amount” or “amount of second additional capital buffer.”

The important loan designation unit 13 may also operate as described below when deriving the scale of bankruptcies on condition of preventing the bankruptcy of the important bank due to the failure of the failed investment and financing destination and the bankruptcy of the borrower of the specified interbank loan. For example, the important loan designation unit 13 may always set, at zero, the amount of the loss of the important bank due to the failure of the failed investment and financing destination and the bankruptcy of the borrower of the specified interbank loan. However, in the example embodiments of the present invention, a case in which the important loan designation unit 13 performs the derivation of the scale of bankruptcies, including the determination of chain-reaction bankruptcies after the temporal addition of the amount of the second additional capital buffer to the amount of the capital buffer of the important bank, is described.

In response to, for example, receiving the bank ID of the important bank, the important loan designation unit 13 extracts the investment and financing destination and the amount of investment and financing in the investment and financing destination, of the important bank. In response to, for example, selecting an interbank loan, the important loan designation unit 13 may further extract the borrower of the selected interbank loan and the amount of the interbank loan, of the important bank. The important bank designation unit 12 may store the extracted amount of the investment and financing and the extracted amount of the interbank loan as an additional capital buffer amount in the second bankruptcy scale storage unit 17. The information of the additional capital buffer amount of the bank, stored in the second bankruptcy scale storage unit 17, is also referred to as “second additional capital buffer information.”

The important loan designation unit 13 may derive an index value representing the second scale of bankruptcies (also referred to as “second index value”) as the second scale of the bankruptcies. The second index value is, for example, the number of banks, among the plurality of banks included in the financial network, that go bankrupt due to the influence of the failure of the failed investment and financing destination under the condition that the bankruptcy of the important bank due to the failure of the failed investment and financing destination and the bankruptcy of the borrower of the selected interbank loan is prevented. In the following description, the condition that bankruptcy of the important bank due to the failure of the failed investment and financing destination and the bankruptcy of the borrower of the selected interbank loan is prevented is referred to as “second condition.” In each example embodiment of the present invention, the derivation of the second index value performed under the second condition by the important loan designation unit 13 is the derivation of the second index value in the state of adding the second additional capital buffer amount to the amount of the capital buffer of the specified bank. In other words, the second index value is, for example, the chain-reaction bankruptcy number due to the influence of the failure of the failed investment and financing destination under the second condition in the plurality of banks included in the financial network. The second index value may be an index value that is not the above-described chain-reaction bankruptcy number, as described below. The important loan designation unit 13 stores information representing the derived second scale of bankruptcies (for example, second index value) in the second bankruptcy scale storage unit 17. In the following description, the information representing the second scale of bankruptcies is also referred to as “second bankruptcy scale information.” In particular, when the second scale of bankruptcies is represented by the chain-reaction bankruptcy number, the information representing the second scale of bankruptcies is also referred to as “second chain-reaction bankruptcy information.”

The second bankruptcy scale storage unit 17 stores the second additional capital buffer information and the second bankruptcy scale information (for example, second chain-reaction bankruptcy information).

The display unit 14 receives the bank ID of the important bank and information (i.e., loan ID) designating the designated important interbank loan from the important loan designation unit 13. The display unit 14 displays the important bank represented by the received bank ID and the designated important interbank loan represented by the received loan ID on, for example, a display device or the like (not illustrated).

Data stored in the bank data storage unit 15, the first bankruptcy scale storage unit 16, and the second bankruptcy scale storage unit 17 may be stored, for example, in the form of a table. The data stored in the form of a table may be recorded as the table on, for example, a relational database. The data stored in the form of a table may be recorded as, for example, a file in text format.

For example, the bank financial information stored in the bank data storage unit 15 may be stored as a bank financial management table in the form of a table in the bank data storage unit 15. The bank financial information is, for example, a combination of the bank ID, investment and financing amount, interbank loan amount, and capital buffer amount of each of the banks included in the plurality of banks included in the financial network.

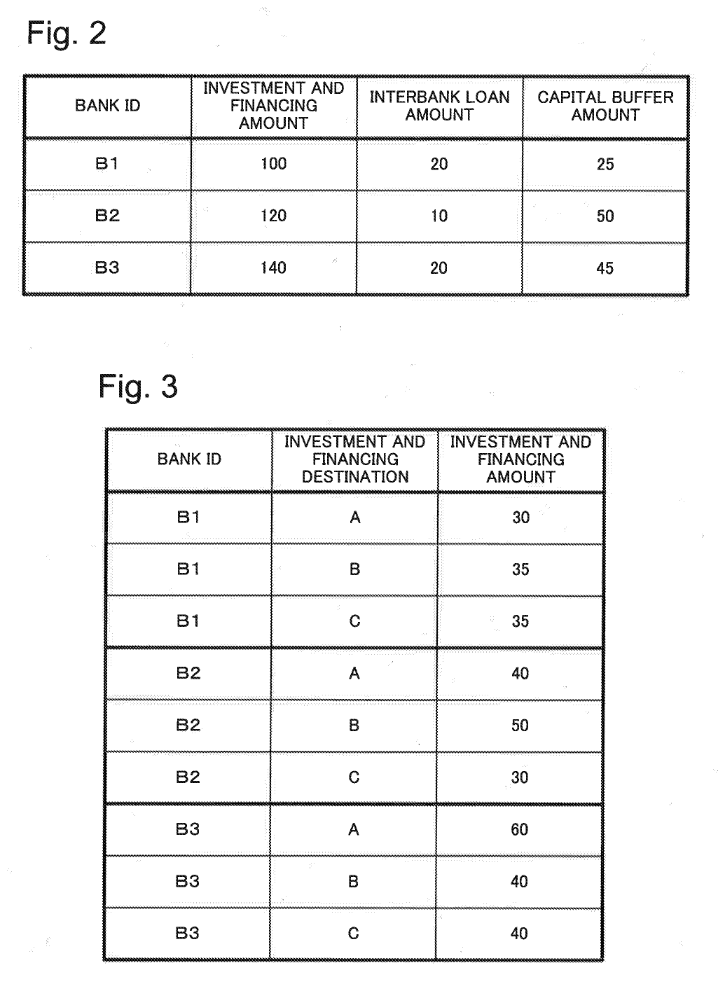

FIG. 2 is a view schematically illustrating an example of the bank financial management table. In the bank financial management table, entries for each of the banks are made in a row. A value in each item of “BANK ID”, “INVESTMENT AND FINANCING AMOUNT”, “INTERBANK LOAN AMOUNT”, and “CAPITAL BUFFER AMOUNT” is recorded for each bank (i.e., each row). The investment and financing amount includes the amounts of all assets such as general loans and securities investments except the amount of a loan due to an interbank loan. When an investment and financing destination fails, an asset price may become zero, whereby a bank may suffer a loss equivalent to an investment and financing amount. The interbank loan amount is the amount of a loan due to an interbank loan. The capital buffer amount is the amount of a capital buffer indicating a capital that need not be paid back and can be immediately used for absorbing a loss. The capital buffer amount is ranked as a core equity capital in a narrow sense.

A bank ID which is an identifier that is capable of individually designating each bank and is assigned in advance to each bank is recorded in the item of “BANK ID.” The bank ID may be represented by a character string. The bank ID may be a code number that is assigned in advance to a bank and is unique to the bank. The bank ID may be a bank name, an abbreviated name unique to the bank, or the like. The total amount of the investment and financing held by the bank is recorded in the item of “INVESTMENT AND FINANCING AMOUNT.” The total amount of the interbank loans held by the bank is recorded in the item of “INTERBANK LOAN AMOUNT.” The amount of the capital buffer held by the bank is recorded in the item of “CAPITAL BUFFER AMOUNT.”

The investment and financing information stored in the bank data storage unit 15 may be stored as an investment and financing management table in a form of a table in the bank data storage unit 15. The investment and financing information is, for example, a combination of the bank ID, the investment and financing destination ID of the investment and financing destination, and the investment and financing amount in the investment and financing destination, of each of the banks included in the plurality of banks included in the financial network.

FIG. 3 is a view schematically illustrating an example of the investment and financing management table. Referring to FIG. 3, entries are made in a row for each of the combinations of banks and investment and financing destinations in the investment and financing management table. A value in each item of “BANK ID”, “investment and financing destination”, and “investment and financing amount” is recorded for each of the combinations of the banks and the investment and financing destinations. The bank ID of a bank making investment and financing is recorded in the item of “BANK ID.” The same bank IDs as the bank IDs used in the bank financial management table are used in the investment and financing management table and each table described below. An investment and financing destination ID which is an identifier that is capable of individually designating each of the investment and financing destinations and is assigned in advance to each of the investment and financing destinations is recorded in the item of “INVESTMENT AND FINANCING DESTINATION.” The investment and financing destination ID may be a code symbol that is assigned to an investment and financing destination and is unique to the investment and financing destination. The investment and financing destination ID may be the name of the investment and financing destination, an abbreviated name unique to the investment and financing destination, or the like. The amount of the investment and financing in the investment and financing destination held by the bank (i.e., the amount of funds invested and financed in the investment and financing destination by the bank) is recorded in the item of “INVESTMENT AND FINANCING AMOUNT.”

The interbank loan information stored in the bank data storage unit 15 may be stored as an interbank loan management table in a form of a table in the bank data storage unit 15. The interbank loan information is, for example, a combination of the bank ID, the bank ID of a bank that is a borrower of an interbank loan, and the amount of the interbank loan, of each of the banks included in the plurality of banks included in the financial network.

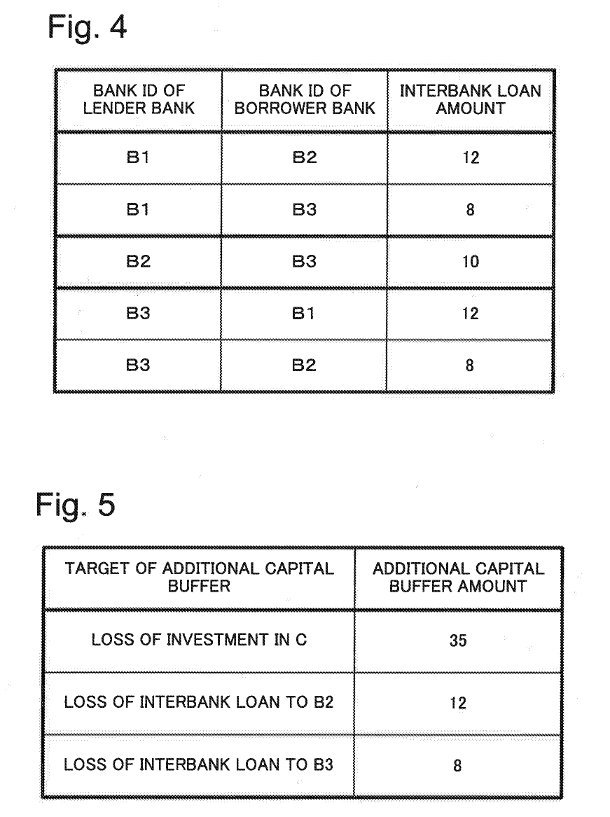

FIG. 4 is a view schematically illustrating an example of the interbank loan management table. Referring to FIG. 4, entries are made in a row for each of the combinations of banks that are lenders and banks that are borrowers in the interbank loan management table. A value in each item of “BANK ID OF LENDER BANK”, “BANK ID OF BORROWER BANK”, and “INTERBANK LOAN AMOUNT” is recorded for each of the combinations of the banks that are lenders and the banks that are borrowers. The bank ID of a bank that is a lender of an interbank loan is recorded in the item of “BANK ID OF LENDER BANK.” The bank ID of a bank that is a borrower of an interbank loan is recorded in the item of “BANK ID OF BORROWER BANK.” The same bank IDs as the bank IDs used in the bank financial management table and the investment and financing management table are also used in the interbank loan management table. The amount of an interbank loan which is a fund loaned to a bank that is a borrower by a bank that is a lender is recorded in “investment and financing amount.”

The first additional capital buffer information stored in the first bankruptcy scale storage unit 16 may be stored as a first additional capital buffer management table in a form of a table in the first bankruptcy scale storage unit 16. The first additional capital buffer information includes a combination of a value including the failed investment and financing destination ID and an additional capital buffer amount equal to the amount of the investment and financing in the failed investment, of a selected bank. The first additional capital buffer information further includes a combination of the bank ID of a bank that is a borrower of the interbank loan and an additional capital buffer amount equal to the amount of the interbank loan, of the selected bank.

FIG. 5 is a view schematically illustrating an example of the first additional capital buffer management table. Referring to FIG. 5, entries are made in a row for each target of an additional capital buffer in a specified bank in the first additional capital buffer management table. A value in each item of “TARGET OF additional CAPITAL BUFFER” and “additional capital buffer amount” is recorded for each target of the additional capital buffer. A value representing the kind of a possible loss which is a target absorbed by the additional capital buffer is recorded in the item of “TARGET OF ADDITIONAL CAPITAL BUFFER.”

Examples of the loss which is the target absorbed by the additional capital buffer in the first additional capital buffer management table include the loss of investment and financing in an investment and financing destination assumed to cause an initial loss due to the failure of the investment and financing destination. Examples of the loss which is the target absorbed by the additional capital buffer in the first additional capital buffer management table also include a loss due to all interbank loans held by a specified bank. The investment and financing in the investment and financing destination assumed to cause an initial loss due to the failure of the investment and financing destination are the investment and financing in the failed investment and financing destination described above. All the interbank loans held by the specified bank are all interbank loans made by the specified bank described above as the lender.

The recorded value representing the kind of the possible loss may be, for example, a value capable of designating an investment and financing destination in which investment and financing that may cause a loss are made. The value capable of designating the investment and financing destination may be a value including the investment and financing destination ID of the investment and financing destination. The value representing the kind of the possible loss may be, for example, a value capable of designating a bank that is a borrower of an interbank loan that may cause a loss. The value capable of designating the bank as the borrower may be a value including the bank ID of the bank that is the borrower.

The amount of an additional capital buffer required when the possible loss is absorbed by the additional capital buffer is recorded in the item of “ADDITIONAL CAPITAL BUFFER AMOUNT.” In the example illustrated in FIG. 5, the investment and financing destination ID of the failed investment and financing destination is “C.” For example, the amount of an additional capital buffer required for absorbing a loss suffered due to investment and financing when the investment and financing destination C fails is 35. For example, the amount of an additional capital buffer required for absorbing a loss suffered due to an interbank loan when the bank B2 that is a borrower goes bankrupt is 12. Such an additional capital buffer amount is equal to an investment and financing amount recorded in the investment and financing management table or an interbank loan amount recorded in the interbank loan management table.

The important bank designation unit 12 may calculate the first additional investment buffer amount described above by totalizing the additional capital buffer amounts recorded in the first additional capital buffer management table.

The first chain-reaction bankruptcy information stored in the first bankruptcy scale storage unit 16 may be stored as a first chain-reaction bankruptcy number management table in a form of a table in the first bankruptcy scale storage unit 16. The first chain-reaction bankruptcy information includes, for example, a combination of the bank ID and the first chain-reaction bankruptcy number on condition that the bank designated by the bank ID is a specified bank, of each of the banks included in the plurality of banks of the financial network. The first chain-reaction bankruptcy information may include, for example, a combination of a value representing that no specified bank exists and the chain-reaction bankruptcy number on condition that no specified bank exists.

FIG. 6 is a view schematically representing an example of the first chain-reaction bankruptcy number management table. Referring to FIG. 6, entries are made in a row for each bank in the chain-reaction bankruptcy number management table. A value in each item of “SPECIFIED BANK” and “CHAIN-REACTION BANKRUPTCY NUMBER” is recorded for each of the banks. The bank ID of a bank specified when the first chain-reaction bankruptcy number is derived under the first condition described above is recorded in the item of “SPECIFIED BANK.” The derived first chain-reaction bankruptcy number is recorded in the item of “CHAIN-REACTION BANKRUPTCY NUMBER.” The chain-reaction bankruptcy number due to the influence of the failure of the failed investment and financing destination on condition that any bank of which the bankruptcy due to the influence of the failure of the failed investment and financing destination described above is prevented does not exist is recorded as the value of “chain-reaction bankruptcy number” in a case in which the bank ID is “none.”

As described above, the important bank designation unit 12 of the present example embodiment first adds the total amount of the additional capital buffer amounts of the specified bank, recorded in the first additional capital buffer management table, to the capital buffer amount of the specified bank when deriving the first chain-reaction bankruptcy number. Accordingly, in FIG. 6, the name of the item of “SPECIFIED BANK” may also be “BANK WITH INCREASED CAPITAL BUFFER.”

The important bank designation unit 12 may derive the chain-reaction bankruptcy number without adding the first additional capital buffer to the capital buffer of any bank. The important bank designation unit 12 may record the chain-reaction bankruptcy number derived in such a manner as the value of “chain-reaction bankruptcy number” in a case in which the bank ID is “none” in the first chain-reaction bankruptcy number management table.

The second additional capital buffer information stored in the second bankruptcy scale storage unit 17 may be stored as a second additional capital buffer management table in a form of a table in the second bankruptcy scale storage unit 17. The second additional capital buffer information includes, for example, a combination of a value including the investment and financing destination ID of a failed investment and financing destination and the amount of an additional capital buffer that is equal to the amount of investment and financing made in the failed investment and financing destination by the bank designated as the important bank. The second additional capital buffer information further includes, for example, a combination of a value including the bank ID of a bank that is a borrower of a specified interbank loan made by the bank designated as the important bank and the amount of an additional capital buffer that is equal to the amount of the interbank loan.

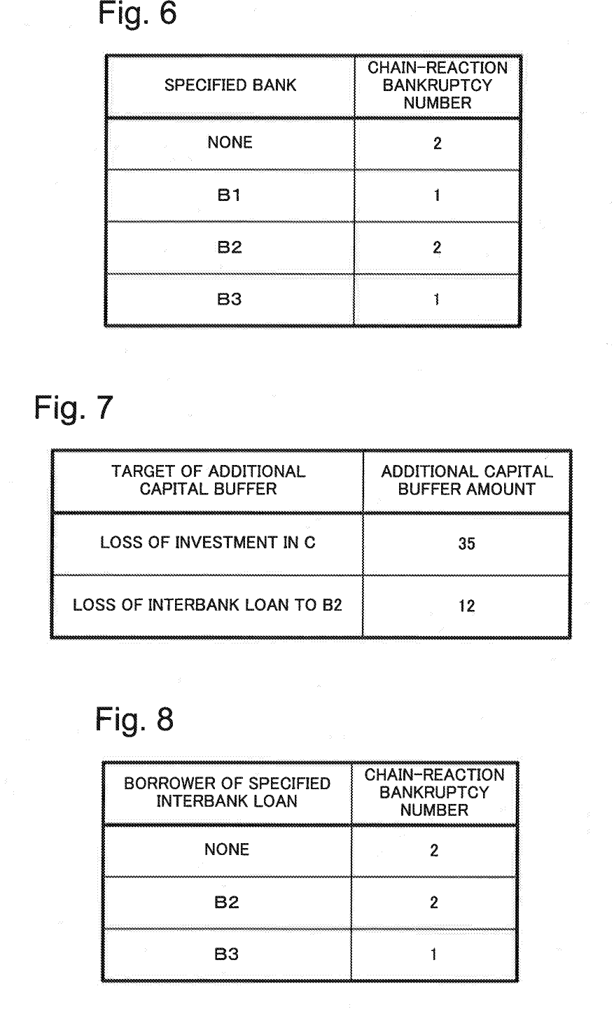

FIG. 7 is a view schematically illustrating an example of the second additional capital buffer management table. Referring to FIG. 7, entries are made in a row for each target of an additional capital buffer in the important bank in the second additional capital buffer management table. A value in each item of “TARGET OF ADDITIONAL CAPITAL BUFFER” and “ADDITIONAL CAPITAL BUFFER AMOUNT” is recorded for each target of the additional capital buffer. A value representing the kind of a possible loss which is a target absorbed by the additional capital buffer is recorded in the item of “TARGET OF ADDITIONAL CAPITAL BUFFER.” The value representing the kind of the possible loss may be set in the same manner as the manner of the value representing the kind of the possible loss in the first additional capital buffer management table illustrated in FIG. 5.

Examples of the loss which is the target absorbed by the additional capital buffer in the second additional capital buffer management table include the loss of investment and financing in an investment and financing destination assumed to cause an initial loss due to the failure of the investment and financing destination. Examples of the loss which is the target absorbed by the additional capital buffer in the second additional capital buffer management table also include a loss due to a specified interbank loan. The investment and financing in the investment and financing destination assumed to cause an initial loss due to the failure of the investment and financing destination are the investment and financing in the failed investment and financing destination described above. The interbank loan by the specified interbank loan is the specified interbank loan made by the above-described important bank as the lender.

The amount of an additional capital buffer required when the possible loss is absorbed by the additional capital buffer is recorded in the item of “ADDITIONAL CAPITAL BUFFER AMOUNT.”

In the example illustrated in FIG. 7, the investment and financing destination ID of the failed investment and financing destination is “C.” A borrower of the specified interbank loan is a bank of which the bank ID is “B2.”

The important loan designation unit 13 may calculate the second additional investment buffer amount described above by totalizing the additional capital buffer amounts recorded in the second additional capital buffer management table.

The second chain-reaction bankruptcy information stored in the second bankruptcy scale storage unit 17 may be stored as a second chain-reaction bankruptcy number management table in a form of a table in the second bankruptcy scale storage unit 17. The second chain-reaction bankruptcy information includes, for example, a combination of the bank ID of the bank that is the borrower of the specified interbank loan and the second chain-reaction bankruptcy number derived on condition that the interbank loan is specified. The second chain-reaction bankruptcy information further includes a combination of a value representing that any bank that is the borrower of the specified interbank loan does not exist and the chain-reaction bankruptcy number on condition that any specified interbank loan does not exist.

FIG. 8 is a view schematically illustrating an example of the second chain-reaction bankruptcy number management table. Referring to FIG. 8, entries are made in a row for each of the specified interbank loans held by the important bank in the second chain-reaction bankruptcy number management table. A value in each item of “BORROWER OF SPECIFIED INTERBANK LOAN” and “CHAIN-REACTION BANKRUPTCY NUMBER” is recorded for each of the specified interbank loans. The bank ID of a bank that is a borrower of the specified interbank loan is recorded in “borrower of specified interbank loan.”

The derived second chain-reaction bankruptcy number is recorded in the item of “CHAIN-REACTION BANKRUPTCY NUMBER.” For example, the chain-reaction bankruptcy number due to the influence of the failure of the failed investment and financing destination on condition that any additional capital buffer that absorbs the loss of the interbank loan is not added to the capital buffer of the important bank may be recorded as the value of “chain-reaction bankruptcy number” in a case in which the bank ID is “none.” For example, the chain-reaction bankruptcy number due to the influence of the failure of the failed investment and financing destination on condition that any additional capital buffer is not added at all to the capital buffer of the important bank may be recorded as the value of “chain-reaction bankruptcy number” in a case in which the bank ID is “none.”

The important loan designation unit 13 may derive the chain-reaction bankruptcy number without adding the additional capital buffer that absorbs the loss of the interbank loan to the capital buffer of the important bank. The important loan designation unit 13 may derive the chain-reaction bankruptcy number without adding any additional capital buffer at all to the capital buffer of the important bank. The important loan designation unit 13 may record the chain-reaction bankruptcy number derived in such a manner as the value of “chain-reaction bankruptcy number” in a case in which the bank ID is “none” in the second chain-reaction bankruptcy number management table.

A case in which the systemic risk management device 1 deals with each table of information (for example, bank financial information or the like) that is also recorded as the tables described above as the above-described table in which the information is recorded in a form of a table (bank financial management table in which bank financial information is recorded, or the like) is described below.

The operation of the systemic risk management device 1 of the present example embodiment will be described next in detail with reference to drawings.

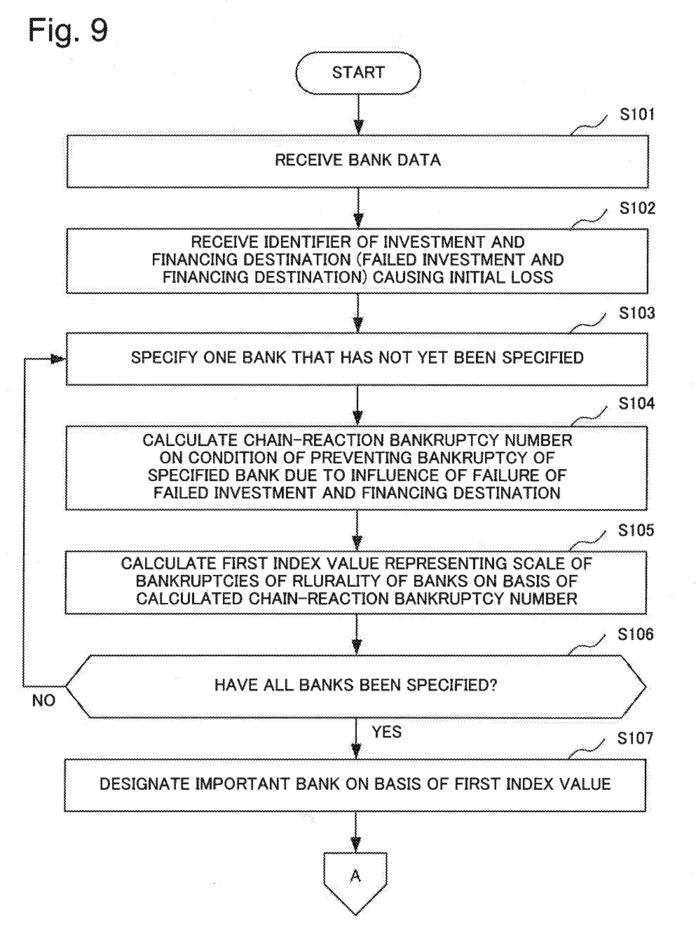

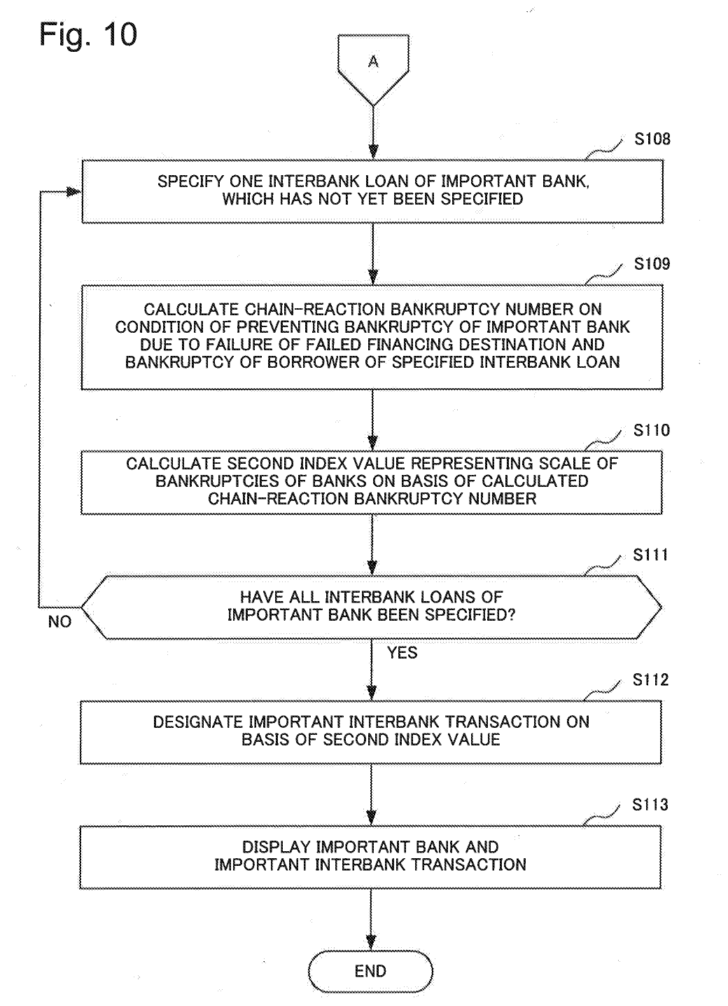

FIG. 9 and FIG. 10 are flowcharts representing an example of an operation of the systemic risk management device 1 of the present example embodiment.

Referring to FIG. 9, first, the data input unit 10 receives bank data from the bank data provision device 2 (step S101). The bank data is, for example, the bank financial management table, the investment and financing management table, and the interbank loan management table, described above. The data input unit 10 stores the received bank data in the bank data storage unit 15.

The data input unit 10 receives the identifier of an investment and financing destination that causes an initial loss (i.e., investment and financing destination ID of failed investment and financing destination) from the indication device 3 (step S102). The data input unit 10 sends the received investment and financing destination ID to the important bank designation unit 12.

The important bank designation unit 12 specifies, for example, a bank that is not specified yet from the banks of which the bank IDs are included in the bank financial management table stored in the bank data storage unit 15 (step S103). Banks included in a financial network are the banks of which the bank IDs are included in the bank financial management table stored in the bank data storage unit 15. The important bank designation unit 12 may specify, in turn, the bank IDs included in the bank financial management table.

The important bank designation unit 12 calculates the chain-reaction bankruptcy number on condition that the bankruptcy of the specified bank due to the influence of the failure of the failed investment and financing destination is prevented (step S104).

The important bank designation unit 12 generates, for example, a first additional capital buffer management table for the specified bank. The important bank designation unit 12 stores the generated first additional capital buffer management table in, for example, the first bankruptcy scale storage unit 16. The important bank designation unit 12 may store the first additional capital buffer management table.

The important bank designation unit 12 extracts the amount of the investment and financing in the failed investment destination from the investment and financing management table. The important bank designation unit 12 further extracts the borrowers and amounts of all interbank loans held by the specified bank from the interbank loan management table. As described above, an interbank loan held by the specified bank is an interbank loan made by the specified bank as a lender. The important bank designation unit 12 records, for example, a combination of the investment and financing destination ID of the extracted failed investment and financing destination and the extracted amount of the investment and financing in the failed investment destination, and a combination of the bank ID of the bank that is the extracted borrower of the interbank loan and the extracted amount of the interbank loan, in the first additional capital buffer management table.

The important bank designation unit 12 totalizes the chain-reaction bankruptcy number by using the generated first additional capital buffer management table. In other words, the important bank designation unit 12 derives the chain-reaction bankruptcy number on condition that the failed investment and financing destination fails in the state of temporarily adding the total amount of additional capital buffers recorded in the first additional capital buffer management table to the capital buffer of the specified bank. The important bank designation unit 12 performs determination on whether individual banks go into bankruptcy in the derivation of the chain-reaction bankruptcy number in a manner described below.

The important bank designation unit 12 reads the amount, which is recorded in the bank financial management table, of the capital buffer of a bank for which determination of whether to go into bankruptcy is performed. The important bank designation unit 12 calculates the total amount of interbank loans in banks determined to have already gone bankrupt among banks that are borrowers of interbank loans made by the bank. The important bank designation unit 12 calculates the sum of the amount of investment and financing made in failed investment and financing destinations by the bank and the calculated total amount of the interbank loans as the amount of the loss of the bank due to the failures of the investment and financing destinations and the failures of the borrowers of the interbank loans. The important bank designation unit 12 compares the amount of the capital buffer of the bank for which determination of whether to go into bankruptcy is performed with the calculated amount of the loss of the bank. When the capital buffer amount is larger than the calculated amount of the loss, the important bank designation unit 12 determines that the bank does not go bankrupt. When the capital buffer amount is smaller than the calculated amount of the loss, the important bank designation unit 12 determines that the bank goes bankrupt.

The additional capital buffers are added to the capital buffer of the specified bank. Therefore, the additional capital buffers absorb the loss due to the investment and financing made in the failed investment and financing destinations by the specified bank, and the loss due to the interbank loans in the banks that are the borrowers of the interbank loans and are determined to have already gone bankrupt. In other words, the investment and financing made in the failed investment and financing destinations by the specified bank, and the amounts of the interbank loans made to the banks that are the borrowers determined to have already gone bankrupt are not included in the amount of the loss, which is compared with the capital buffer, of the specified bank. The important bank designation unit 12 continues the determination of whether to go into bankruptcy for a bank that newly suffers a loss until the propagation of losses ends. The important bank designation unit 12 totalizes the number of banks that have gone bankrupt before the propagation of the losses ends, and considers the totalized number as the chain-reaction bankruptcy number. The chain-reaction bankruptcy number derived in step S104 is the above-described first chain-reaction bankruptcy number. The important bank designation unit 12 records the derived chain-reaction bankruptcy number in the first chain-reaction bankruptcy number management table.

The important bank designation unit 12 calculates a first index value representing the scale of the bankruptcies of the banks on the basis of the chain-reaction bankruptcy number calculated in step S104 (step S105). In the description of the present example embodiment, the first index value is the first chain-reaction bankruptcy number. Accordingly, the important bank designation unit 12 may consider the derived first chain-reaction bankruptcy number as the first index value.

When any bank that is not specified yet exists (NO in step S106), the important bank designation unit 12 performs the operations after step S103. When all the banks included in the financial network (i.e., of which the bank IDs are included in the bank financial management table) are specified (YES in step S106), the important bank designation unit 12 designates an important bank on the basis of first index values (step S107). The important bank designation unit 12 designates, as the important bank, a bank specified when deriving, for example, the lowest first index value of the first index values derived in step S105.

As described above, in the present example embodiment, the first index value is the chain-reaction bankruptcy number (the above-described first chain-reaction bankruptcy number) recorded in the first chain-reaction bankruptcy number management table. The important bank designation unit 12 refers to the first chain-reaction bankruptcy number management table. The important bank designation unit 12 designates, as the important bank, for example, a bank specified when deriving the smallest chain-reaction bankruptcy number in the chain-reaction bankruptcy numbers recorded in the first chain-reaction bankruptcy number management table.

The important bank designation unit 12 sends the bank ID of the designated important bank (i.e., the bank ID of the bank designated as the important bank) to the important loan designation unit 13.

After the operation of step S107, the operation of step S108 illustrated in FIG. 10 is performed.

The important loan designation unit 13 specifies an interbank loan that is not yet specified yet among interbank loans made by the important bank (step S108). The important loan designation unit 13 specifies, in turn, for example, interbank loans made by the important bank, included in the interbank loan management table stored in the bank data storage unit 15.

The important loan designation unit 13 calculates the chain-reaction bankruptcy number on condition that the bankruptcy of the important bank due to the failure of a failed financing destination and the bankruptcy of a borrower of the specified interbank loan is prevented (step S109).

The important loan designation unit 13 generates a second additional capital buffer management table relating to the specified interbank loan.

The important loan designation unit 13 extracts the amount of investment and financing in the failed investment destinations, held by the important bank, from the investment and financing management table. In other words, the important loan designation unit 13 extracts the amount of the investment and financing made in the failed investment destinations by the important bank. The important loan designation unit 13 further reads the bank ID of the bank that is the borrower of the specified interbank loan and the amount of the specified interbank loan from the interbank loan management table. The important loan designation unit 13 records, in the first additional capital buffer management table, a combination of the investment and financing destination ID of the failed investment and financing destination and the amount of the investment and financing in the failed investment destination, and a combination of the bank ID of the bank as the borrower of the specified interbank loan and the amount of the interbank loan.

The important loan designation unit 13 totalizes the chain-reaction bankruptcy number by using the generated second additional capital buffer management table. In other words, the important loan designation unit 13 derives the chain-reaction bankruptcy number on condition that the failed investment and financing destination fails in the state of temporarily adding the total amount of the additional capital buffers recorded in the second additional capital buffer management table to the capital buffer of the important bank. The important loan designation unit 13 performs determination on whether individual banks go into bankruptcy in the derivation of the chain-reaction bankruptcy number in a manner described below.

The important loan designation unit 13 reads the amount, which is recorded in the bank financial management table, of the capital buffer of a bank for which determination of whether to go into bankruptcy is performed. The important loan designation unit 13 calculates the total amount of interbank loans in banks determined to have already gone bankrupt among banks that are borrowers of interbank loans by the bank. The important loan designation unit 13 calculates the sum of the amount of the investment and financing made in failed investment and financing destinations by the bank and the calculated total amount of the interbank loans as the amount of the loss of the bank due to the failures of the investment and financing destinations and the failures of the borrowers of the interbank loans. The important loan designation unit 13 compares the amount of the capital buffer of the bank for which determination of whether to go into bankruptcy is performed with the calculated amount of the loss of the bank. When the capital buffer amount is more than the calculated amount of the loss, the important loan designation unit 13 determines that the bank does not go bankrupt. When the capital buffer amount is less than the calculated amount of the loss, the important loan designation unit 13 determines that the bank goes bankrupt.

The additional capital buffers are added to the capital buffer of the important bank. Therefore, the additional capital buffers absorb the loss due to the investment and financing made in the failed investment and financing destination by the important bank and the loss due to the specified interbank loan on condition that the bank which is the borrower of the specified interbank loan goes bankrupt. In other words, the investment and financing made in the failed investment and financing destination by the important bank, and the amount of the specified interbank loan on condition that the bank which is the borrower of the specified interbank loan is determined to have already gone bankrupt are not included in the amount of the loss, which is compared with the capital buffer, of the specified bank. The important loan designation unit 13 continues the determination of whether to go into bankruptcy for a bank that newly suffers a loss until the propagation of losses ends. The important loan designation unit 13 totalizes the number of banks that have gone bankrupt before the propagation of the losses ends, and considers the totalized number as the chain-reaction bankruptcy number. The chain-reaction bankruptcy number derived in step S109 is the above-described second chain-reaction bankruptcy number. The important loan designation unit 13 records the derived chain-reaction bankruptcy number in the second chain-reaction bankruptcy number management table.

The important loan designation unit 13 calculates a second index value representing the scale of the bankruptcies of the banks on the basis of the number of the chain-reaction bankruptcies calculated in step S109 (step S110). In the description of the present example embodiment, the second index value is the second chain-reaction bankruptcy number. Accordingly, the important loan designation unit 13 may consider the derived second chain-reaction bankruptcy number as the second index value.

When any interbank loan that is not yet specified yet as an interbank loan of the important bank exists (NO in step S111), the important loan designation unit 13 repeats the operations from step S108. When all the interbank loans of the important bank are specified (YES in step S111), the important loan designation unit 13 designates an important interbank transaction on the basis of the second index values (step S112). The important loan designation unit 13 designates, as the important interbank loan, an interbank loan specified when deriving, for example, the lowest second index value in the second index values derived in step S110.

As described above, in the present example embodiment, the second index value is the chain-reaction bankruptcy number (the above-described the second chain-reaction bankruptcy number) recorded in the second chain-reaction bankruptcy number management table. The important loan designation unit 13 refers to the second chain-reaction bankruptcy number management table. The important loan designation unit 13 designates, as the important interbank loan, for example, an interbank loan specified when deriving the smallest chain-reaction bankruptcy number in the chain-reaction bankruptcy numbers recorded in the second chain-reaction bankruptcy number management table.

The important loan designation unit 13 sends the bank ID of the important bank and information designating the important interbank loan to the display unit 14. As described above, the information designating the important interbank loan is, for example, a combination of the bank ID of the bank that is the lender of the important interbank loan (i.e., important bank) and the bank ID of the bank that is the borrower of the important interbank loan. Accordingly, in such a case, the important loan designation unit 13 may send the bank ID of the important bank and the bank ID of the bank that is the borrower of the important interbank loan to the display unit 14.

Then, the display unit 14 displays the important bank and the important interbank transaction (step S113). A display form in which the display unit 14 displays the important bank and the important interbank transaction may be any form in which the important bank and the important interbank transaction can be designated. The display form in which the display unit 14 displays the important bank and the important interbank transaction may be set, for example, by a administrator of the systemic risk management system 100. The display unit 14 may read the amount of the important interbank transaction from, for example, the bank data storage unit 15, and may further display the read amount of the interbank transaction.

### Operation Example Based on First Example Embodiment

An operation example based on the first example embodiment will be described next in detail with reference to drawings.

FIG. 5 is a first additional capital buffer management table in a case in which the bank ID of a specified bank is B1 and a failed investment and financing destination is an investment and financing destination C. In the following description, a bank may be represented using the bank ID of the bank. For example, a bank of which the bank ID is B1 is referred to as “bank B1.”

In the first additional capital buffer management table illustrated in FIG. 5, the amount of an additional capital buffer required for absorbing a loss suffered from investment and financing in the investment and financing destination C in a case in which the investment and financing destination C fails is 35. In a case in which a bank of which the identifier is B2 goes bankrupt, the amount of an additional capital buffer required for absorbing a loss suffered from an interbank loan made to a borrower by the bank is 12. In a case in which a bank of which the identifier is B3 goes bankrupt, the amount of an additional capital buffer required for absorbing a loss suffered from an interbank loan made to a borrower by the bank is 8. In addition, the capital buffer amount of the specified bank (i.e., the bank of which the bank ID is B1), recorded in the bank financial management table illustrated in FIG. 2, is 25.

The important bank designation unit 12 temporarily adds the total amount of the additional capital buffers recorded in the first additional capital buffer management table to the amount of the capital buffer of a specified bank recorded in the bank financial management table. The important bank designation unit 12 considers the sum of the total amounts of the additional capital buffers recorded in the first additional capital buffer management table and the amount of the capital buffer of the specified bank recorded in the bank financial management table as the amount of the effective capital buffer of the specified bank. In the above-described example, the amount of the effective capital buffer of the bank B1 which is the specified bank is 80 that is the total of the amount of the additional capital buffers illustrated in FIGS. 5 and 25 that is the amount of the capital buffer of the bank of which bank ID recorded in the bank financial management table is B1. The important bank designation unit 12 totalizes the chain-reaction bankruptcy number, by using, for example, such a model as described in Background Art, under the condition that the capital buffer held by the bank B1 is 80.

In the example of the first chain-reaction bankruptcy number management table illustrated in FIG. 6, the chain-reaction bankruptcy number on condition that the specified bank is the bank B1 is 1. The chain-reaction bankruptcy number on condition that the specified bank is the bank B2 is 2. The chain-reaction bankruptcy number on condition that the specified bank is the bank B3 is 3. Accordingly, in this example, the banks specified when the smallest chain-reaction bankruptcy number is derived are the bank B1 and the bank B3. In other words, the important banks are the bank B1 and the bank B3. When a plurality of banks are designated as important banks, the important loan designation unit 13 may specify all the interbank loans of each of the important banks in turn. When a plurality of banks are designated as the important banks, the important loan designation unit 13 may further select one important bank from the important banks according to, for example, a predetermined method. A case in which the bank B1 is designated as an important bank will be described below.

FIG. 7 is the example of the second additional capital buffer management table in a case in which the failed investment and financing destination is the investment and financing destination C, the important bank is the bank B1, and the borrower of the specified interbank loan is a bank B2. In the second additional capital buffer management table illustrated in FIG. 7, on condition that the investment and financing destination C fails, the amount of an additional capital buffer required for absorbing a loss suffered due to investment and financing in the investment and financing destination C is 35. On condition that the bank B2 that is the borrower of the specified interbank loan goes bankrupt, the amount of an additional capital buffer required for absorbing a loss due to the specified interbank loan is 12.

The important loan designation unit 13 temporarily adds the total amount of the additional capital buffers recorded in the second additional capital buffer management table to the amount of the capital buffer of the important bank recorded in the bank financial management table. The important loan designation unit 13 considers the sum of the total amount of the additional capital buffers recorded in the second additional capital buffer management table and the amount of the capital buffer of the important bank recorded in the bank financial management table as the amount of the effective capital buffer of the important bank. In the above-described example, the amount of the effective capital buffer of the bank B1 which is the important bank is 72 that is the total of the amount of the additional capital buffers illustrated in FIGS. 7 and 25 that is the amount of the capital buffer of the bank B1 recorded in the bank financial management table. The important loan designation unit 13 totalizes the chain-reaction bankruptcy number, by using, for example, such a model as described in Background Art, under the condition that the capital buffer held by the bank B1 is 72.

In the example of the second chain-reaction bankruptcy number management table illustrated in FIG. 8, the chain-reaction bankruptcy number on condition that the bank which is the borrower of the specified interbank loan is the bank B2 is 2. The chain-reaction bankruptcy number on condition that the bank that is the borrower of the specified interbank loan is the bank B3 is 1. Accordingly, in this example, the bank that is the borrower of the interbank loan specified when the smallest chain-reaction bankruptcy number is derived is B3. In other words, the important loan is an interbank loan made to the bank B3 by the important bank B1.

The present example embodiment described above has the first effect of being capable of designating an important part with regard to a systemic risk in a financial network.

The present example embodiment further has the second effect of being capable of easily managing the systemic risk.

The reason of the first effect and the second effect is because the important bank designation unit 12 designates an important bank and the important loan designation unit 13 designates an important interbank loan from interbank loans made by the important bank.

The important bank designation unit 12 designates, as an important bank, a bank of which the prevention of the bankruptcy causes the smallest scale of bankruptcies in a financial network. In other words, the important bank designation unit 12 designates, as the important bank, the most important bank in banks from the viewpoint of contribution to a reduction in systemic risk. The important bank designated by the important bank designation unit 12 can be considered as a bank requiring the most significant improvement from the viewpoint of contribution to a reduction in systemic risk.

The important loan designation unit 13 designates, as an important interbank loan, an interbank loan of which the prevention of a loss due to the bankruptcy of a bank that is a borrower causes the smallest scale of bankruptcies in a financial network. In other words, the important loan designation unit 13 designates, as the important interbank loan, the most important interbank loan in banks from the viewpoint of contribution to a reduction in systemic risk. The important interbank loan designated by the important bank designation unit 12 can be considered as an interbank loan requiring the most significant improvement from the viewpoint of contribution to a reduction in systemic risk.

As described above, an important bank and an important interbank loan made by the important bank, which are important parts in a financial network, can be designated in the present example embodiment.

Accordingly, a systemic risk can be easily managed.

### Second Example Embodiment

A second example embodiment of the present invention will be described next in detail with reference to drawings.

FIG. 1 is a view illustrating the configuration of a systemic risk management system 100 of the present example embodiment. The configuration of the systemic risk management system 100 of the present example embodiment is the same as the configuration of the systemic risk management system 100 of the first example embodiment. The components of the present example embodiment are the same as the components, to which the same names are assigned, of the first example embodiment, except differences described below. The operations of the present example embodiment are the same as the operations, to which the same reference signs are assigned, of the first example embodiment, except differences described below.

In step S105 illustrated in FIG. 9, an important bank designation unit 12 of the present example embodiment derives, as a first index value, an index value other than the first chain-reaction bankruptcy number. The value derived as the first index value by the important bank designation unit 12 is, for example, a to-capital chain-reaction bankruptcy improvement rate, a large-asset bank bankruptcy ratio, a leading bank bankruptcy ratio, a bankruptcy growth rate, or the like. The to-capital chain-reaction bankruptcy improvement rate, the large-asset bank bankruptcy ratio, the leading bank bankruptcy ratio, and the bankruptcy growth rate will be described in detail later. The important bank designation unit 12 further records the first index value in a first chain-reaction bankruptcy number management table.

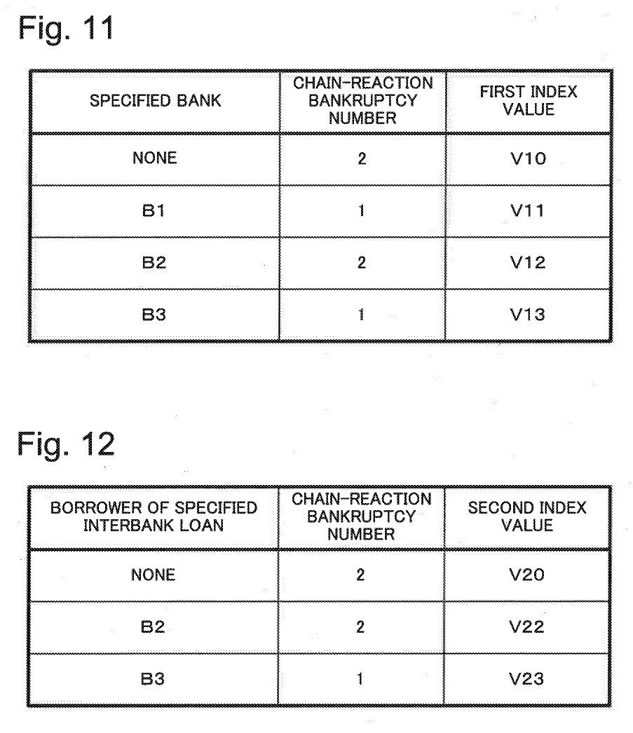

FIG. 11 is a view schematically illustrating an example of the first chain-reaction bankruptcy number management table in the present example embodiment. In FIG. 11, a value in an item of which the item name is “FIRST INDEX VALUE” represents the first index value.

An important loan designation unit 13 of the present example embodiment derives, as a second index value, an index value other than the second chain-reaction bankruptcy number in step S109 illustrated in FIG. 10. The value derived as the second index value by the important loan designation unit 13 is, for example, a to-capital chain-reaction bankruptcy improvement rate, a large-asset bank bankruptcy ratio, a leading bank bankruptcy ratio, a bankruptcy growth rate, or the like. The important loan designation unit 13 further records the second index value in a second chain-reaction bankruptcy number management table.

FIG. 12 is a view schematically illustrating an example of the second chain-reaction bankruptcy number management table in the present example embodiment. In FIG. 12, a value in an item of which the item name is “SECOND INDEX VALUE” represents the second index value.

The systemic risk management system 100 of the present example embodiment is the same as the systemic risk management system 100 of the first example embodiment except the above-described differences. Description of the same points of the systemic risk management system 100 of the present example embodiment as those of the systemic risk management system 100 of the first example embodiment is omitted.

The to-capital chain-reaction bankruptcy improvement rate, the large-asset bank bankruptcy ratio, the leading bank bankruptcy ratio, and the bankruptcy growth rate will be described below.

The “to-capital chain-reaction bankruptcy improvement rate” is the ratio of a chain-reaction bankruptcy improvement number in a specified state to the increment of the total amount of additional capital buffers in the specified state. In other words, the to-capital chain-reaction bankruptcy improvement rate is a value obtained by dividing the chain-reaction bankruptcy improvement number in the specified state by the increment of the total amount of the additional capital buffers in the specified state.

The specified state may be, for example, a state in which the amount of the first additional capital buffer described above is added to the amount of the capital buffer of a specified bank. The specified state may be, for example, a state in which the amount of the second additional capital buffer described above is added to the amount of the capital buffer of an important bank. The increment of the total amount of the additional capital buffers is, for example, the increment of the total amount of additional capital buffers in a specified state from the total amount of additional capital buffers in a predetermined reference state. In other words, the increment is a value obtained by subtracting the total amount of the additional capital buffers in the predetermined reference state from the total amount of the additional capital buffers in the specified state. The above-described reference state is, for example, a state in which an additional capital buffer is not added to the capital buffer of any bank. The reference state may be another state set in advance. The chain-reaction bankruptcy improvement number is, for example, the increment of the chain-reaction bankruptcy number in the above-described reference state from the chain-reaction bankruptcy number in a specified state. In the following description, the reference state is a state in which an additional capital buffer is not added to the capital buffer of any bank.

In the example of the first additional capital buffer management table illustrated in FIG. 5, the amount of an additional capital buffer in a case in which the bank B1 is a specified bank is 55. In the reference state, an additional capital buffer is not added to the capital buffer of any bank, and therefore, the amount of the additional capital buffer is zero. In the example of the first chain-reaction bankruptcy number management table illustrated in FIG. 6, the chain-reaction bankruptcy number on condition that the bank B1 is the specified bank is 1. The chain-reaction bankruptcy number on condition that the specified bank is “none” (i.e., in the reference state) is 2. The chain-reaction bankruptcy improvement number is 1 that is a value obtained by subtracting 1 which is the chain-reaction bankruptcy number on condition that the bank B1 is the specified bank from 2 which is the chain-reaction bankruptcy number on condition that the specified bank is “none.” In the above-described example, the to-capital chain-reaction bankruptcy improvement rate is a value obtained by dividing 1 which is the chain-reaction bankruptcy improvement number by 55 which is the amount of the additional capital buffer on condition that the bank B1 is the specified bank.

The “large-asset bank bankruptcy ratio” represents the ratio of large-asset banks in banks that have gone bankrupt. In other words, the large-asset bank bankruptcy ratio is a value obtained by dividing the number of large-asset banks determined to have gone bankrupt before the propagation of losses ends by the number of chain-reaction bankruptcies. A large-asset bank refers to a bank of which the total value of the investment and financing amount and the interbank loan amount is larger than a predetermined asset threshold value. For example, in a case in which the asset threshold value is 150, the bank B3 corresponds to such a large-asset bank in the example of the bank financial management table illustrated in FIG. 2.

The “leading bank bankruptcy ratio” is the ratio of leading banks in banks that have gone bankrupt. In other words, the leading bank bankruptcy ratio is a value obtained by dividing the number of leading banks determined to have gone bankrupt before the propagation of losses ends by the number of chain-reaction bankruptcies. A leading bank refers to a bank of which the rank of the total value of the investment and financing amount and the interbank loan amount in banks included in a financial network is equal to or higher than a rank indicated by a predetermined rank threshold value. In a case in which the rank threshold value is 2, the bank B2 and the bank B3 correspond to such leading banks in the example of the bank financial management table illustrated in FIG. 2.

The “bankruptcy growth rate” is the ratio of the number of initial bankruptcies to the number of final chain-reaction bankruptcies. The number of the initial bankruptcies is the number of bankruptcies just after one of investment and financing destinations has failed. The number of the initial bankruptcies is, for example, the number of banks determined to have gone bankrupt due to only the loss of investment and financing in a failed investment and financing destination. The number of the final chain-reaction bankruptcies is the number of final chain-reaction bankruptcies after the propagation of losses ends due to the failure of the investment and financing destination. The numbers of chain-reaction bankruptcies illustrated in FIG. 11 and FIG. 12 are the numbers of final chain-reaction bankruptcies. For example, in a case in which the number of initial bankruptcies is 1 and the number of final chain-reaction bankruptcies is 2, the bankruptcy growth rate is 2 that is a value obtained by dividing 2 which is the number of the final chain-reaction bankruptcies by 1 which is the number of the initial bankruptcies.

The present example embodiment described above has the same effects as the effects of the first example embodiment. The reason thereof is the same as the reason why the effects of the first example embodiment are exhibited.

### Third Example Embodiment

A third example embodiment of the present invention will be described next in detail with reference to drawings.

FIG. 1 is a view illustrating the configuration of a systemic risk management system 100 of the present example embodiment. The configuration of the systemic risk management system 100 of the present example embodiment is the same as the configuration of the systemic risk management system 100 of the second example embodiment. The components of the present example embodiment are the same as the components, to which the same names are assigned, of the second example embodiment, except differences described below. The operations of the present example embodiment are the same as the operations, to which the reference signs are assigned, of the second example embodiment, except differences described below.

A data input unit 10 of the present example embodiment receives the kind of a first index value and the kind of a second index value from an indication device 3. For example, a user of the systemic risk management system 100 may specify the kind of the first index value and the kind of the second index value.

The kind of the first index value represents the chain-reaction bankruptcy number, the to-capital chain-reaction bankruptcy improvement rate, the large-asset bank bankruptcy ratio, the leading bank bankruptcy ratio, or the bankruptcy growth rate. The data input unit 10 receives, as the kind of the first index value, for example, a value indicating the chain-reaction bankruptcy number, a value indicating the to-capital chain-reaction bankruptcy improvement rate, a value indicating the large-asset bank bankruptcy ratio, a value indicating the leading bank bankruptcy ratio, or a value indicating the bankruptcy growth rate, which are set in advance and are different from each other.

The kind of the second index value represents the chain-reaction bankruptcy number, the to-capital chain-reaction bankruptcy improvement rate, the large-asset bank bankruptcy ratio, the leading bank bankruptcy ratio, or the bankruptcy growth rate. The data input unit 10 receives, as the kind of the second index value, for example, a value indicating the chain-reaction bankruptcy number, a value indicating the to-capital chain-reaction bankruptcy improvement rate, a value indicating the large-asset bank bankruptcy ratio, a value indicating the leading bank bankruptcy ratio, or a value indicating the bankruptcy growth rate, which are set in advance and are different from each other. The kind of the second index value may be different from the kind of the first index value.

The data input unit 10 sends the kind of the first index value to an important bank designation unit 12. The data input unit 10 sends the kind of the first index value to an important loan designation unit 13 via, for example, the important bank designation unit 12. The data input unit 10 may directly send the kind of the first index value to the important loan designation unit 13.

In step S105 illustrated in FIG. 9, the important bank designation unit 12 of the present example embodiment derives, as a first index value, a first index value of the kind designated by the received kind of the first index value. The value derived as the first index value by the important bank designation unit 12 is, for example, the to-capital chain-reaction bankruptcy improvement rate, the large-asset bank bankruptcy ratio, the leading bank bankruptcy ratio, the bankruptcy growth rate, or the like. When the received kind of the first index value is the chain-reaction bankruptcy number, the important bank designation unit 12 may set the derived first chain-reaction bankruptcy number as the first index value.

In step S110 illustrated in FIG. 10, the important loan designation unit 13 of the present example embodiment derives, as a second index value, a second index value of the kind designated by the received kind of the second index value. The value derived as the second index value by the important bank designation unit 12 is, for example, the to-capital chain-reaction bankruptcy improvement rate, the large-asset bank bankruptcy ratio, the leading bank bankruptcy ratio, the bankruptcy growth rate, or the like. When the received kind of the second index value is the chain-reaction bankruptcy number, the important loan designation unit 13 may set the derived second chain-reaction bankruptcy number as the second index value.

The present example embodiment described above has the same effects as the effects of the first example embodiment. The reason thereof is the same as the reason why the effects of the first example embodiment are exhibited.

The present example embodiment further has the third effect of being capable of designating an important part with regard to a systemic risk from various viewpoints in a financial network.

The reason thereof is because the important bank designation unit 12 derives the first index value of the kind designated by the received kind of the first index value. In addition, the reason is because the important loan designation unit 13 derives the second index value of the kind designated by the received kind of the second index value.

### Fourth Example Embodiment

A fourth example embodiment of the present invention will now be described in detail with reference to drawings.

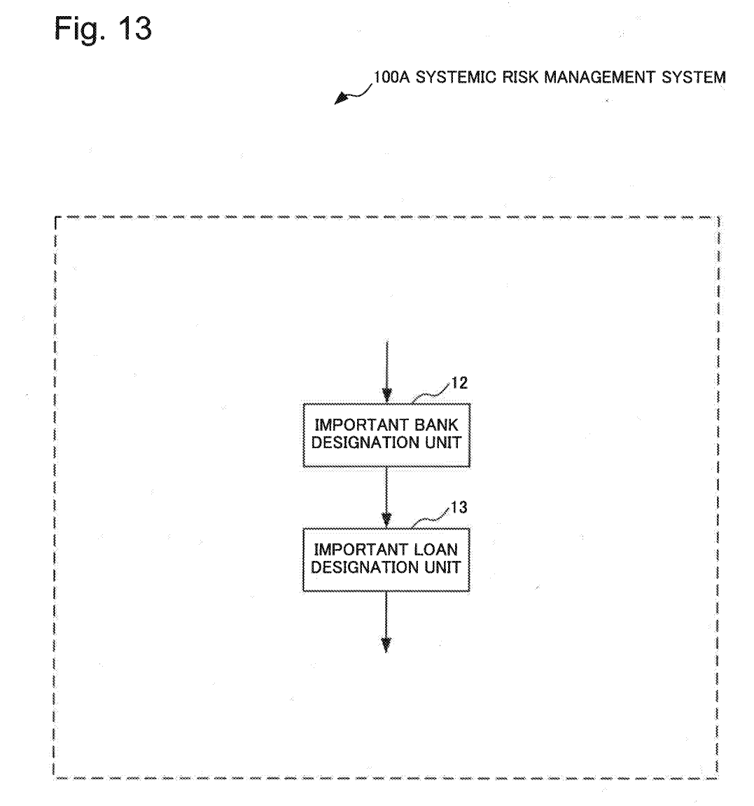

FIG. 13 is a block diagram illustrating an example of the configuring of a systemic risk management system 100A of the present example embodiment.

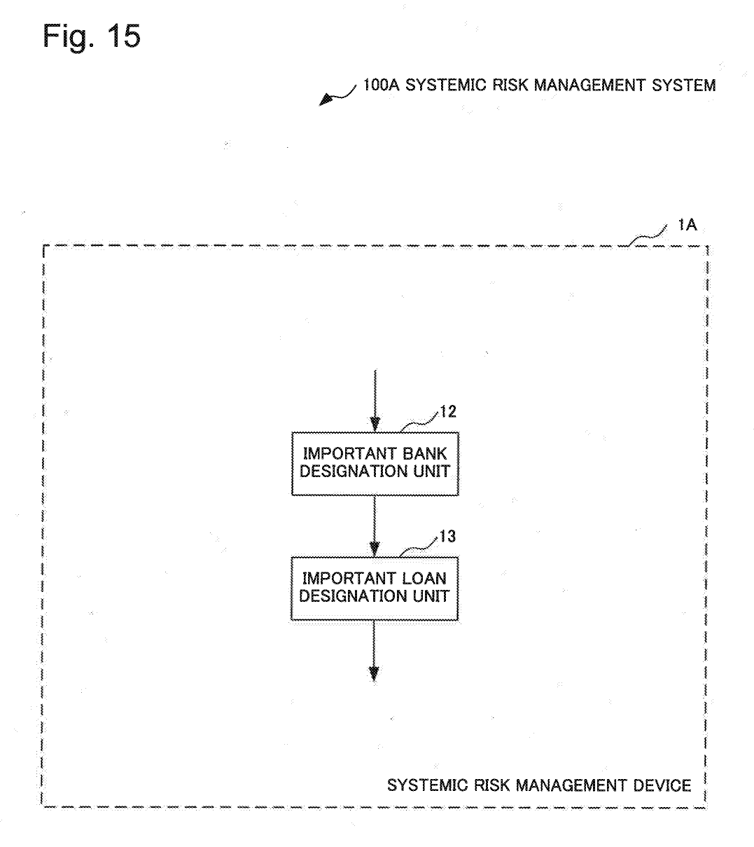

FIG. 15 is a block diagram illustrating another example of the configuring of the systemic risk management system 100A of the present example embodiment. For example, as illustrated in FIG. 15, the systemic risk management system 100A of the present example embodiment may be implemented as a systemic risk management device 1A which is one device. The systemic risk management system 100A may be implemented as a plurality of devices. When the systemic risk management system 100A is implemented as a plurality of devices, the plurality of devices may be communicably connected through a communication network and the like. The communication network is implemented with at least either wired communication or wireless communication. The systemic risk management system 100A of the present example embodiment may further include a bank data provision device (not illustrated) and an indication device (not illustrated) that are connected communicably to the systemic risk management device 1A through a communication network. The bank data provision device and indication device of the present example embodiment are the same as the bank data provision device 2 and indication device 3 of the first example embodiment, respectively.

The systemic risk management system 100A includes an important bank designation unit 12 and an important loan designation unit 13. The important bank designation unit 12 designates an important bank from a plurality of banks in which an interbank loan is made on the basis of the smallness of the first scale of bankruptcies. The first scale of the bankruptcies is the scale of the bankruptcies of the plurality of banks due to the influence of the failure of a predetermined investment and financing destination on condition of preventing the bankruptcy of a bank included in the plurality of banks due to the influence of the failure of the predetermined investment and financing destination in which investment and financing are made by at least any one of the plurality of banks. The important loan designation unit 13 designates an important interbank loan from one or more interbank loans made by the important bank, on the basis of the smallness of the second scale of bankruptcies. The second scale of the bankruptcies is the scale of bankruptcies of the plurality of banks due to the influence of the failure of the predetermined investment and financing destination on condition of preventing the bankruptcy of the important bank due to the bankruptcy and failure of a bank that is a borrower of an interbank loan included in one or more interbank loans.

The operations of the systemic risk management system 100A of the present example embodiment will be described next in detail with reference to drawings.

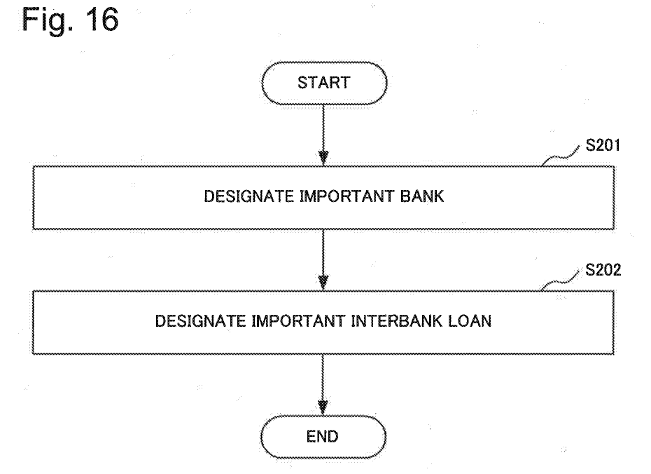

FIG. 16 is a flowchart illustrating an example of the operations of the systemic risk management system 100A of the present example embodiment.

Referring to FIG. 16, first, the important bank designation unit 12 designates an important bank from a plurality of banks in which an interbank loan is made on the basis of the smallness of the first scale of bankruptcies (step S201). Then, the important loan designation unit 13 designates an important interbank loan from one or more interbank loans made by the important bank, on the basis of the smallness of the second scale of bankruptcies (step S202).

The present example embodiment has the same effects as the effects of the first example embodiment. The reason thereof is the same as the reason why the effects of the first example embodiment are exhibited.

### Other Example Embodiment

Each of the systemic risk management devices according to the example embodiments of the present invention can be implemented by circuitry. The circuitry is a computer including, for example, a processor and a memory into which a program executed by the processor is loaded. The circuitry may be a plurality of computers that are communicably connected. The circuitry is, for example, a dedicated circuit. The circuitry may be a plurality of circuits that are connected communicably to each other. The circuitry may be a combination of one or more computers and one or more circuits that are communicably connected.

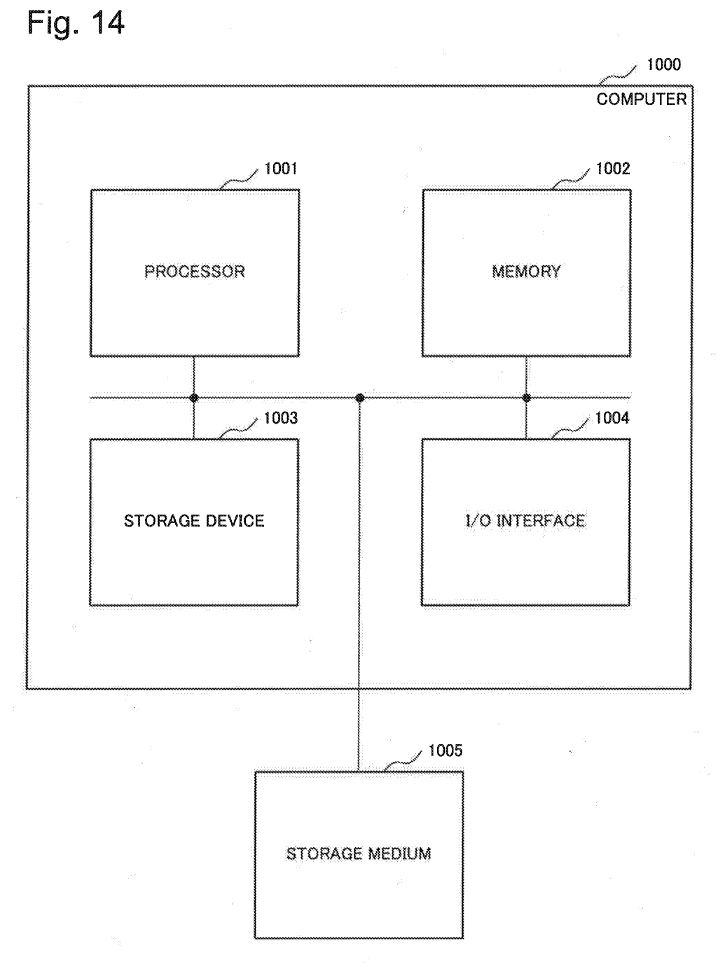

FIG. 14 is a view illustrating an example of a hardware configuration of a computer 1000 with which the systemic risk management devices 1 and 1A can be implemented. Referring to FIG. 14, the computer 1000 includes a processor 1001, a memory 1002, a storage device 1003, and an I/O (input/output) interface 1004. The computer 1000 can access a storage medium 1005. The memory 1002 and the storage device 1003 are, for example, storage devices such as a RAM (random access memory) and a hard disk. The storage medium 1005 is, for example, a storage device such as a RAM or a hard disk, a ROM (read only memory), or a removable storage medium. The storage device 1003 may be the storage medium 1005. The processor 1001 can read and write data and a program from and into the memory 1002 and the storage device 1003. The processor 1001 can communicate with, for example, the bank data provision device 2, the indication device 3, and a display device (not illustrated) via the I/O interface 1004. The processor 1001 can access the storage medium 1005. The storage medium 1005 stores a program that causes the computer 1000 to operate as the systemic risk management device 1 or 1A.

The processor 1001 loads, into the memory 1002, the program that is stored in the storage medium 1005 and causes the computer 1000 to operate as the systemic risk management device 1 or 1A. The processor 1001 executes the program loaded into the memory 1002, thereby causing the computer 1000 to operate as the systemic risk management device 1 or 1A.

Each unit included in a first group described below can be implemented by, for example, a dedicated program that is read from the storage medium 1005 storing the program into the memory 1002 and can achieve the function of each unit, and by the processor 1001 which executes the program. The first group includes the data input unit 10, the important bank designation unit 12, the important loan designation unit 13, and the display unit 14.

Each unit included in a second group described below can be implemented by the memory 1002 and the storage device 1003 such as a hard disk device which are included in the computer 1000. The second group includes the bank data storage unit 15, the first bankruptcy scale storage unit 16, and the second bankruptcy scale storage unit 17.

Alternatively, a part or all of all the units included in the first group and the second group can also be implemented by a dedicated circuit that achieves the functions of their respective units.

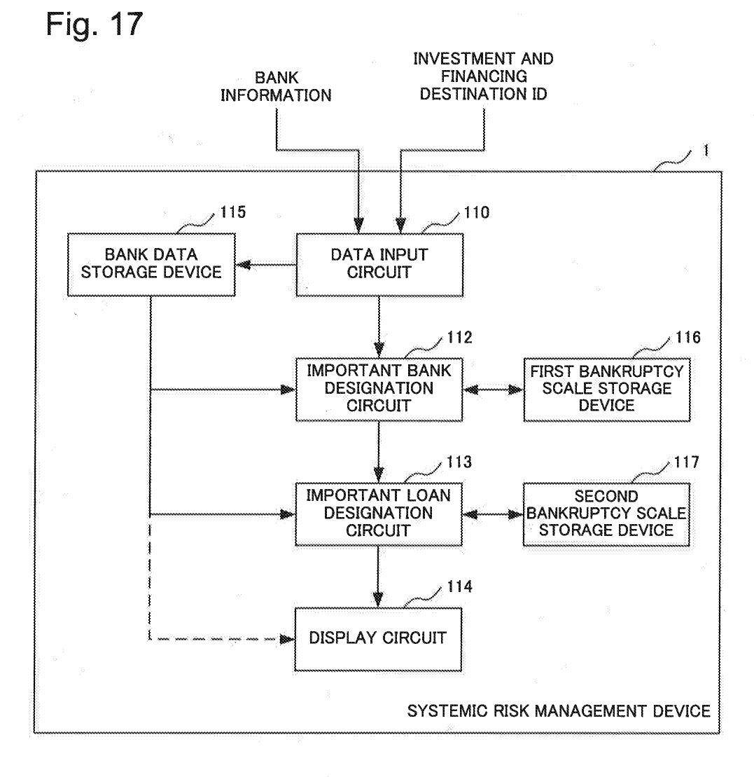

FIG. 17 is a block diagram illustrating an example of the configurations, implemented by a dedicated circuit, of the systemic risk management devices 1 according to the first, second, and third example embodiments of the present invention. Referring to FIG. 17, the systemic risk management device 1 includes a data input circuit 110, an important bank designation circuit 112, an important loan designation circuit 113, a display circuit 114, a bank data storage device 115, a first bankruptcy scale storage device 116, and a second bankruptcy scale storage device 117.

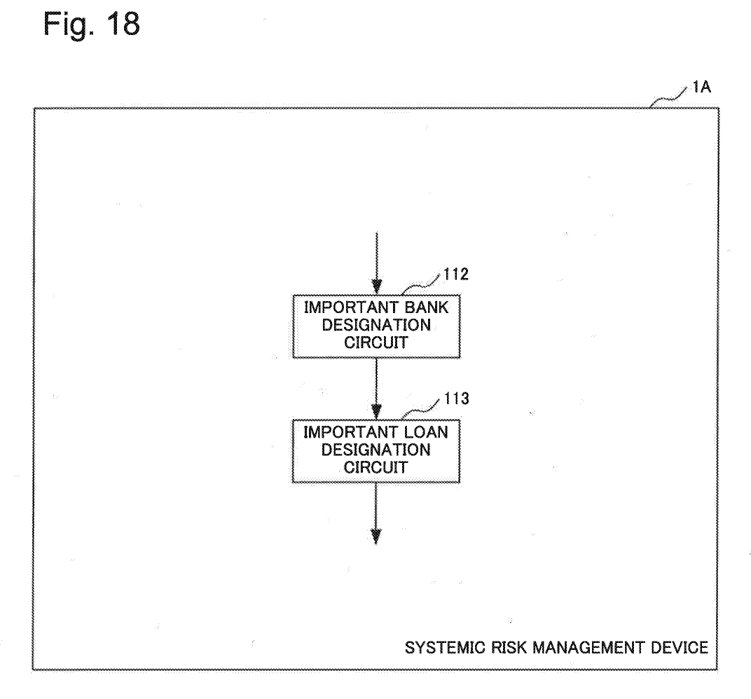

FIG. 18 is a block diagram illustrating an example of the configuration, implemented by a dedicated circuit, of the systemic risk management device 1A according to the fourth example embodiment of the present invention. Referring to FIG. 18, the systemic risk management device 1A includes an important bank designation circuit 112 and an important loan designation circuit 113.

The data input unit 10 is achieved by the data input circuit 110. The data input circuit 110 operates as the data input unit 10. The important bank designation unit 12 is achieved by the important bank designation circuit 112. The important bank designation circuit 112 operates as the important bank designation unit 12. The important loan designation unit 13 is achieved by the important loan designation circuit 113. The important loan designation circuit 113 operates as the important loan designation unit 13. The display unit 14 is achieved by the display circuit 114. The display circuit 114 operates as the display unit 14. The bank data storage unit 15 is achieved by the bank data storage device 115. The bank data storage device 115 operates as the bank data storage unit 15. The first bankruptcy scale storage unit 16 is achieved by the first bankruptcy scale storage device 116. The first bankruptcy scale storage device 116 operates as the first bankruptcy scale storage unit 16. The second bankruptcy scale storage unit 17 is achieved by the second bankruptcy scale storage device 117. The second bankruptcy scale storage device 117 operates as the second bankruptcy scale storage unit 17.

A part or all of the example embodiments described above can also be described as in the following Supplementary Notes but are not limited thereto.

(Supplementary Note 1)

A systemic risk management system including:

important bank designation means for designating an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and

important loan designation means for designating an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

(Supplementary Note 2)

The systemic risk management system according to Supplementary Note 1, wherein

the important bank designation means derives the first scale of bankruptcies based on bank financial data, investment and financing data, and interbank loan data of the plurality of banks, the bank financial data including an amount of a capital buffer which is a capital that is capable of being used for absorbing a loss, the investment and financing data including an investment and financing amount for each investment and financing destination, the interbank loan data including an amount of an interbank loan made by each bank as a borrower, and

the important loan designation means derives the second scale of bankruptcies based on the bank financial data, the investment and financing data, and the interbank loan data of the plurality of banks.

(Supplementary Note 3)

The systemic risk management system according to Supplementary Note 1 or 2, wherein

the important bank designation means calculates a first index value representing a scale of bankruptcies of the plurality of banks due to the influence of the failure on condition of preventing a bankruptcy of a bank included in the plurality of banks due to the influence of the failure, and selects the important bank from the plurality of banks based on the smallness of a scale of bankruptcies, the scale being represented by the first index value, thereby designating the important bank.

(Supplementary Note 4)

The systemic risk management system according to any one of Supplementary Notes 1 to 3, wherein

the important loan designation means calculates a second index value representing the second scale of bankruptcies of the plurality of banks due to the influence of the failure on condition of preventing a bankruptcy of the important bank due to a bankruptcy of a bank being a borrower of an interbank loan included in a plurality of interbank loans made by the important bank and the failure, and selects the important interbank loan from the plurality of interbank loans based on smallness of a scale of bankruptcies, the scale being represented by the second index value, thereby designating the important interbank loan.

(Supplementary Note 5)

The systemic risk management system according to Supplementary Note 4, wherein

the first index value is any one of:

a chain-reaction bankruptcy number which is a count of banks going bankrupt due to the failure among the plurality of banks;

a large-asset bank bankruptcy ratio which is a rate of a large-capital bank in the banks going bankrupt, the large-capital bank being a bank of which a total value of an investment and financing amount and an interbank loan amount is more than a predetermined value;

a leading bank bankruptcy ratio that is a rate of a leading bank in the banks going bankrupt, the leading bank being a bank of which a rank of magnitude of the total value is not less than a predetermined rank;

a bankruptcy growth rate that is a rate of a count of banks going bankrupt due to a loss of interbank loans made to an other bank going bankrupt due to the failure to a count of banks going bankrupt due to a loss of investment and financing caused by the failure among the plurality of banks; and

a to-capital chain-reaction bankruptcy improvement rate that is a chain-reaction bankruptcy improvement number per unit of an additional capital buffer which is a capital which is capable of being used for absorbing a loss and is added, thereby being capable of absorbing a loss due to the bankruptcies of the banks, the chain-reaction bankruptcy improvement number being a decrement of a count of the chain-reaction bankruptcies on condition that the additional capital buffer is added from a count of the chain-reaction bankruptcies on condition that the additional capital buffer is not added, and

the second index is any one of the chain-reaction bankruptcies number, the large-asset bank bankruptcy ratio, the bankruptcy growth rate, and the to-capital chain-reaction bankruptcy improvement rate.

(Supplementary Note 6)

The systemic risk management system according to any one of Supplementary Notes 1 to 5, wherein

the important bank designation means sets an amount obtained by adding an amount that is not less than an amount of a loss due to influence of a failure of an investment and financing destination to the amount of the capital buffer used for absorbing the loss of the banks as the amount of the capital buffer, thereby deriving the first scale of bankruptcies of banks, and

the important loan designation means sets an amount obtained by adding an amount of a loss due to the bankruptcy of the bank that is the borrower of the interbank loan included in the at least one interbank loan and a failure of the investment and financing destination to the amount of the capital buffer used for absorbing the loss of the important bank as the amount of the capital buffer, thereby deriving the second scale of bankruptcies of banks.

(Supplementary Note 7)

A systemic risk management method including:

designating an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and

designating an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

(Supplementary Note 8)

The systemic risk management method according to Supplementary Note 7, including:

deriving the first scale of bankruptcies is derived based on bank financial data, investment and financing data, and interbank loan data of the plurality of banks, the bank financial data including an amount of a capital buffer which is a capital that is capable of being used for absorbing a loss, the investment and financing data including an investment and financing amount for each investment and financing destination, the interbank loan data including an amount of an interbank loan made by each bank as a borrower, wherein

the second scale of bankruptcies is derived based on the bank financial data, the investment and financing data, and the interbank loan data of the plurality of banks.

(Supplementary Note 9)

The systemic risk management method according to Supplementary Note 7 or 8, including:

calculating a first index value representing a scale of bankruptcies of the plurality of banks due to the influence of the failure on condition of preventing a bankruptcy of a bank included in the plurality of banks due to the influence of the failure, and selecting the important bank from the plurality of banks based on the smallness of a scale of bankruptcies, the scale being represented by the first index value, thereby designating the important bank.

(Supplementary Note 10)

The systemic risk management method according to any one of Supplementary Notes 7 to 9, including:

calculating a second index value representing the second scale of bankruptcies of the plurality of banks due to the influence of the failure on condition of preventing a bankruptcy of the important bank due to a bankruptcy of a bank being a borrower of an interbank loan included in a plurality of interbank loans made by the important bank and the failure, and selecting the important interbank loan from the plurality of interbank loans based on smallness of a scale of bankruptcies, the scale being represented by the second index value, thereby designating the important interbank loan.

(Supplementary Note 11)

The systemic risk management method according to Supplementary Note 10, wherein

the first index value is any one of:

a chain-reaction bankruptcy number which is a count of banks going bankrupt due to the failure among the plurality of banks;

a large-asset bank bankruptcy ratio which is a rate of a large-capital bank in the banks going bankrupt, the large-capital bank being a bank of which a total value of an investment and financing amount and an interbank loan amount is more than a predetermined value;

a leading bank bankruptcy ratio that is a rate of a leading bank in the banks going bankrupt, the leading bank being a bank of which a rank of magnitude of the total value is not less than a predetermined rank;

a bankruptcy growth rate that is a rate of a count of banks going bankrupt due to a loss of interbank loans made to an other bank going bankrupt due to the failure to a count of banks going bankrupt due to a loss of investment and financing caused by the failure among the plurality of banks; and

a to-capital chain-reaction bankruptcy improvement rate that is a chain-reaction bankruptcy improvement number per unit of an additional capital buffer which is a capital which is capable of being used for absorbing a loss and is added, thereby being capable of absorbing a loss due to the bankruptcies of the banks, the chain-reaction bankruptcy improvement number being a decrement of a count of the chain-reaction bankruptcies on condition that the additional capital buffer is added from a count of the chain-reaction bankruptcies on condition that the additional capital buffer is not added, and

the second index is any one of the chain-reaction bankruptcies number, the large-asset bank bankruptcy ratio, the bankruptcy growth rate, and the to-capital chain-reaction bankruptcy improvement rate.

(Supplementary Note 12)

The systemic risk management method according to any one of Supplementary Notes 7 to 11, including:

setting an amount obtained by adding an amount that is not less than an amount of a loss due to influence of a failure of an investment and financing destination to the amount of the capital buffer used for absorbing the loss of the banks as the amount of the capital buffer, thereby deriving the first scale of bankruptcies of banks; and

setting an amount obtained by adding an amount of a loss due to the bankruptcy of the bank that is the borrower of the interbank loan included in the at least one interbank loan and a failure of the investment and financing destination to the amount of the capital buffer used for absorbing the loss of the important bank as the amount of the capital buffer, thereby deriving the second scale of bankruptcies of banks.

(Supplementary Note 13)

A systemic risk management program that causes a computer to execute:

important bank designation processing that designates an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and

important loan designation processing that designates an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

(Supplementary Note 14)

The systemic risk management program according to Supplementary Note 13, wherein

the important bank designation processing derives the first scale of bankruptcies based on bank financial data, investment and financing data, and interbank loan data of the plurality of banks, the bank financial data including an amount of a capital buffer which is a capital that is capable of being used for absorbing a loss, the investment and financing data including an investment and financing amount for each investment and financing destination, the interbank loan data including an amount of an interbank loan made by each bank as a borrower, and

the important loan designation processing derives the second scale of bankruptcies based on the bank financial data, the investment and financing data, and the interbank loan data of the plurality of banks.

(Supplementary Note 15)

The systemic risk management program according to Supplementary Note 13 or 14, wherein

the important bank designation processing calculates a first index value representing a scale of bankruptcies of the plurality of banks due to the influence of the failure on condition of preventing a bankruptcy of a bank included in the plurality of banks due to the influence of the failure, and selects the important bank from the plurality of banks based on the smallness of a scale of bankruptcies, the scale being represented by the first index value, thereby designating the important bank.

(Supplementary Note 16)

The systemic risk management program according to any one of Supplementary Notes 13 to 15, wherein

the important loan designation processing calculates a second index value representing the second scale of bankruptcies of the plurality of banks due to the influence of the failure on condition of preventing a bankruptcy of the important bank due to a bankruptcy of a bank being a borrower of an interbank loan included in a plurality of interbank loans made by the important bank and the failure, and selects the important interbank loan from the plurality of interbank loans based on smallness of a scale of bankruptcies, the scale being represented by the second index value, thereby designating the important interbank loan.

(Supplementary Note 17)

The systemic risk management program according to Supplementary Note 16, wherein

the first index value is any one of:

a chain-reaction bankruptcy number which is a count of banks going bankrupt due to the failure among the plurality of banks;

a large-asset bank bankruptcy ratio which is a rate of a large-capital bank in the banks going bankrupt, the large-capital bank being a bank of which a total value of an investment and financing amount and an interbank loan amount is more than a predetermined value;

a leading bank bankruptcy ratio that is a rate of a leading bank in the banks going bankrupt, the leading bank being a bank of which a rank of magnitude of the total value is not less than a predetermined rank;

a bankruptcy growth rate that is a rate of a count of banks going bankrupt due to a loss of interbank loans made to an other bank going bankrupt due to the failure to a count of banks going bankrupt due to a loss of investment and financing caused by the failure among the plurality of banks; and

a to-capital chain-reaction bankruptcy improvement rate that is a chain-reaction bankruptcy improvement number per unit of an additional capital buffer which is a capital which is capable of being used for absorbing a loss and is added, thereby being capable of absorbing a loss due to the bankruptcies of the banks, the chain-reaction bankruptcy improvement number being a decrement of a count of the chain-reaction bankruptcies on condition that the additional capital buffer is added from a count of the chain-reaction bankruptcies on condition that the additional capital buffer is not added, and

the second index is any one of the chain-reaction bankruptcies number, the large-asset bank bankruptcy ratio, the bankruptcy growth rate, and the to-capital chain-reaction bankruptcy improvement rate.

(Supplementary Note 18)

The systemic risk management program according to any one of Supplementary Notes 13 to 17, wherein

the important bank designation processing sets an amount obtained by adding an amount that is not less than an amount of a loss due to influence of a failure of an investment and financing destination to the amount of the capital buffer used for absorbing the loss of the banks as the amount of the capital buffer, thereby deriving the first scale of bankruptcies of banks, and

the important loan designation processing sets an amount obtained by adding an amount of a loss due to the bankruptcy of the bank that is the borrower of the interbank loan included in the at least one interbank loan and a failure of the investment and financing destination to the amount of the capital buffer used for absorbing the loss of the important bank as the amount of the capital buffer, thereby deriving the second scale of bankruptcies of banks.

(Supplementary Note 19)

A storage medium storing a systemic risk management program according any one of Supplementary Notes 13 to 18.

The present invention is described above with reference to the example embodiments. However, the present invention is not limited to the example embodiments described above. Various modifications that can be understood by those skilled in the art within the scope of the present invention can be made in the configuration and details of the present invention.

This application claims priority based on Japanese Patent Application No. 2015-033996, which was filed on Feb. 24, 2015, and the entire disclosure of which is incorporated herein.

### INDUSTRIAL APPLICABILITY

The present invention can be applied to applications in which an important bank requiring the most significant improvement under present circumstances and an important interbank loan in which the important bank is involved and which requires the most significant improvement are designated in order to reduce a systemic risk. The present invention can be applied to applications in which management of a systemic risk is facilitated in a financial network. The financial network means, for example, a graph-like structure representing an interbank transaction relationship including an interbank loan of funds, as described above. The systemic risk refers to, for example, the risk of collapse of the entire financial network rather than the risk of the bankruptcy of an individual bank. In other words, the systemic risk refers to, for example, the risk of occurrence of very serious chain-reaction bankruptcies.

### REFERENCE SIGNS LIST

1 Systemic risk management device
1A Systemic risk management device
2 Bank data provision device
3 Indication device
10 Data input unit
12 Important bank designation unit
13 Important loan designation unit
14 Display unit
15 Bank data storage unit
16 First bankruptcy scale storage unit
17 Second bankruptcy scale storage unit
100 Systemic risk management system
100A Systemic risk management system
110 Data input circuit
112 Important bank designation circuit
113 Important loan designation circuit
114 Display circuit
115 Bank data storage device
116 First bankruptcy scale storage device
117 Second bankruptcy scale storage device
1000 Computer
1001 Processor
1002 Memory
1003 Storage device
1004 I/O interface
1005 Storage medium

What is claimed is:

1. A systemic risk management system comprising:
a memory that stores a set of instructions; and
at least one first processor configured to execute the set of instructions to:
designate an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and
designate an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

2. The systemic risk management system according to claim 1, wherein
the at least one first processor is further configured to:
derive the first scale of bankruptcies based on bank financial data, investment and financing data, and interbank loan data of the plurality of banks, the bank financial data including an amount of a capital buffer which is a capital that is capable of being used for absorbing a loss, the investment and financing data including an investment and financing amount for each investment and financing destination, the interbank loan data including an amount of an interbank loan made by each bank as a borrower, and
derive the second scale of bankruptcies based on the bank financial data, the investment and financing data, and the interbank loan data of the plurality of banks.

3. The systemic risk management system according to claim 1, wherein
the at least one first processor is further configured to:
calculate a first index value representing a scale of bankruptcies of the plurality of banks due to the influence of the failure on condition of preventing a bankruptcy of a bank included in the plurality of banks due to the influence of the failure, and select the important bank from the plurality of banks based on the smallness of a scale of bankruptcies, the scale being represented by the first index value, thereby designating the important bank.

4. The systemic risk management system according to claim 1, wherein
the at least one first processor is further configured to:
calculate a second index value representing the second scale of bankruptcies of the plurality of banks due to the influence of the failure on condition of preventing a bankruptcy of the important bank due to a bankruptcy of a bank being a borrower of an interbank loan included in a plurality of interbank loans made by the important bank and the failure, and select the important interbank loan from the plurality of interbank loans based on smallness of a scale of bankruptcies, the scale being represented by the second index value, thereby designating the important interbank loan.

5. The systemic risk management system according to claim 4, wherein
the first index value is any one of:
a chain-reaction bankruptcy number which is a count of banks going bankrupt due to the failure among the plurality of banks;
a large-asset bank bankruptcy ratio which is a rate of a large-capital bank in the banks going bankrupt, the large-capital bank being a bank of which a total value of an investment and financing amount and an interbank loan amount is more than a predetermined value;
a leading bank bankruptcy ratio that is a rate of a leading bank in the banks going bankrupt, the leading bank being a bank of which a rank of magnitude of the total value is not less than a predetermined rank;
a bankruptcy growth rate that is a rate of a count of banks going bankrupt due to a loss of interbank loans made to another bank going bankrupt due to the failure to a count of banks going bankrupt due to a loss of investment and financing caused by the failure among the plurality of banks; and
a to-capital chain-reaction bankruptcy improvement rate that is a chain-reaction bankruptcy improvement number per unit of an additional capital buffer which is a capital which is capable of being used for absorbing a loss and is added, thereby being capable of absorbing a loss due to the bankruptcies of the banks, the chain-reaction bankruptcy improvement number being a decrement of a count of the chain-reaction bankruptcies on condition that the additional capital buffer is added from a count of the chain-reaction bankruptcies on condition that the additional capital buffer is not added, and
the second index is any one of the chain-reaction bankruptcies number, the large-asset bank bankruptcy ratio, the bankruptcy growth rate, and the to-capital chain-reaction bankruptcy improvement rate.

6. The systemic risk management system according to claim 1, wherein
the at least one first processor is further configured to:
set an amount obtained by adding an amount that is not less than an amount of a loss due to influence of a failure of an investment and financing destination to the amount of the capital buffer used for absorbing the loss of the banks as the amount of the capital buffer, thereby deriving the first scale of bankruptcies of banks, and
set an amount obtained by adding an amount of a loss due to the bankruptcy of the bank that is the borrower of the interbank loan included in the at least one interbank loan and a failure of the investment and financing destination to the amount of the capital buffer used for absorbing the loss of the important bank as the amount of the capital buffer, thereby deriving the second scale of bankruptcies of banks.

7. A systemic risk management method comprising:
designating an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and
designating an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

8. The systemic risk management method according to claim 7, comprising:
deriving the first scale of bankruptcies is derived based on bank financial data, investment and financing data, and interbank loan data of the plurality of banks, the bank financial data including an amount of a capital buffer which is a capital that is capable of being used for absorbing a loss, the investment and financing data including an investment and financing amount for each investment and financing destination, the interbank loan data including an amount of an interbank loan made by each bank as a borrower; and
the second scale of bankruptcies is derived based on the bank financial data, the investment and financing data, and the interbank loan data of the plurality of banks.

9. A non-transitory computer readable storage medium storing a systemic risk management program that causes a computer to execute:
important bank designation processing that designates an important bank from a plurality of banks in which an interbank loan is made based on smallness of a first scale of bankruptcies, the first scale being a scale of bankruptcies of the plurality of banks due to an influence of a failure of a predetermined investment and financing destination on condition of preventing a bankruptcy of a bank included in the plurality of banks due to the influence of the failure of the predetermined investment and financing destination in which investment and financing are made by at least any one of the plurality of banks; and
important loan designation processing that designates an important interbank loan from at least one interbank loan made by the important bank based on smallness of a second scale of bankruptcies, the second scale being a scale of bankruptcies of the plurality of banks due to the influence of the failure of the predetermined investment and financing destination on condition of preventing a bankruptcy of the important bank due to a bankruptcy of a bank being a borrower of an interbank loan included in the at least one interbank loan and the failure of the predetermined investment and financing destination.

10. The non-transitory computer readable storage medium according to claim 9, the storage medium storing the systemic risk management program, wherein
the important bank designation processing derives the first scale of bankruptcies based on bank financial data, investment and financing data, and interbank loan data of the plurality of banks, the bank financial data including an amount of a capital buffer which is a capital that is capable of being used for absorbing a loss, the investment and financing data including an investment and financing amount for each investment and financing destination, the interbank loan data including an amount of an interbank loan made by each bank as a borrower, and
the important loan designation processing derives the second scale of bankruptcies based on the bank financial data, the investment and financing data, and the interbank loan data of the plurality of banks.
